(19) United States
(12) Patent Application Publication
(10) Pub. No.: US 2026/0359497 A1
(43) Pub. Date: Nov. 12, 2026

(54) TAMPER RESPONSIVE PASSTHROUGH MODULE AND SYSTEM FOR PROTECTING SENSITIVE DEVICES

(71) Applicant: TAMPERSEC, INC.., Dover, DE (US)

(72) Inventors: Jonathan Happel, Tann (Rhoen) (GE); Nathaniel Theis, Petaluma, CA (US); Jackson Joseph Dean, San Francisco, CA (US)

(73) Assignee: TAMPERSEC, INC.., Dover, DE (US)

(21) Appl. No.: 19/534,741

(22) Filed: Feb. 9, 2026

Related U.S. Application Data
(60) Provisional application No. 63/756,151, filed on Feb. 8, 2025.

(51) Int. Cl. G06F 21/86; G01D 5/16; G01D 5/26

(52) U.S. Cl. CPC G06F 21/86; G01D 5/16; G01D 5/268

(57) ABSTRACT

A tamper-responsive passthrough module comprises at least one sensor structure comprising at least one sensor element and at least one passthrough defined through the sensor structure. The passthrough comprises a plurality of openings connected by a non-linear path bounded by the sensor structure, such that any straight-line path through the passthrough intersects the sensor structure. A plurality of modules may be coupled to form continuous perimeter enclosing a protected volume. A processing circuit monitors measurable properties of the sensor structure to detect tampering. Functional elements including electrical power conductors, signal conductors, optical conductors, cooling fluid, cooling gas, thermally conductive material, and mechanical fastening elements may be routed through the passthrough along the non-linear path. The system enables comprehensive tamper detection while maintaining operational access to a protected device.

The present application claims priority of provisional US application No. 63/756151, filed on Feb. 8, 2025 and entitled: “SYSTEM AND METHOD FOR PROTECTING SENSITIVE DEVICES AGAINST TAMPERING”, which is hereby incorporated by reference in its entirety.

### BACKGROUND OF THE INVENTION

### Field of the Invention

The present invention relates to tamper-detection systems and methods. More specifically, the present invention relates to modular tamper-responsive enclosures with passthrough interfaces for protecting sensitive electronic devices against physical tampering.

### Description of the Related Art

The protection of sensitive electronic devices against physical tampering and unauthorized access is a critical concern across numerous industries. Devices that process or store cryptographic keys, confidential data, or other sensitive information may require protection against both physical intrusion and side-channel attacks.

For electronic devices requiring active tamper detection, existing approaches typically employ flexible films with conductive traces wrapped around the device and bonded to form a sealed envelope. These enclosures detect intrusion by monitoring electrical properties of the conductive traces for changes indicative of physical manipulation. While providing a level of tamper detection, such approaches face several limitations.

First, flexible films wrapped around a device create a thermally insulative barrier that impedes heat dissipation. For high-power devices such as graphics processing units generating hundreds of watts, this thermal constraint is a significant limitation, as the film prevents direct thermal contact between the device and external heat sinks or cooling systems.

Second, such approaches commonly employ flexible printed circuit boards to route power and data connections through the secure perimeter. While flexible printed circuit boards are well suited for carrying electrical traces, they inherently limit the types of functional elements that can traverse the secure perimeter to electrical connections. Routing other functional elements such as fiber optic cables, air cooling pathways, liquid cooling channels, or structural fasteners through a flexible printed circuit board envelope is difficult or impractical, limiting the range of devices and operational configurations that can be protected.

Third, where functional elements are routed through the sealed envelope, the envelope must be interrupted, and the integrity of tamper coverage at these entry points depends on the assembly and sealing procedure. Such interruptions may create gaps or areas of insufficient sensor coverage.

Hence, a need remains in the art for a tamper-detection solution that can protect sensitive devices against tampering while enabling effective thermal management of high-power devices, accommodating diverse functional elements through the secure perimeter, and providing structurally defined coverage that is not dependent on the assembly process.

### SUMMARY OF THE INVENTION

The need in the art is addressed by the tamper-responsive passthrough module and tamper-detection system of the present invention.

In one aspect, a tamper-responsive passthrough module comprises at least one sensor structure comprising at least one sensor element, and at least one passthrough defined through the sensor structure. The passthrough comprises a plurality of openings connected by a non-linear path. Physical stimulus upon the sensor structure causes a detectable change in at least one property of the sensor structure. The non-linear path is bounded by the sensor structure such that any straight-line path through the passthrough intersects the sensor structure. This geometry prevents an attacker from bypassing tamper detection by creating a straight path through the module.

In another aspect, a tamper-detection system comprises at least one tamper-responsive module with at least one sensor structure comprising at least one sensor element, and a processing circuit operationally coupled to the sensor structure. The processing circuit is configured to detect tampering based on changes in at least one measurable property of the sensor structure. A plurality of tamper-responsive modules may be coupled to form a continuous perimeter enclosing a protected volume, with decoupling or displacement of modules causing a detectable change. Various functional elements may be routed through the passthrough along the non-linear path, enabling operational access to the protected volume while maintaining continuous tamper detection.

In another aspect, a method of providing tamper-detected access through a tamper-detection module comprises providing a sensor structure having at least one measurable property, defining a passthrough through the sensor structure following a non-linear path bounded by the sensor structure, routing at least one functional element through the passthrough along the non-linear path, and monitoring the measurable property to detect physical manipulation of the sensor structure.

The system is particularly suited for securing cryptographic hardware security modules, secure data storage units, graphics processing units, AI accelerators, and other sensitive electronic devices against physical tampering.

Embodiments of this presentation include a tamper-responsive passthrough module comprising:
(a) at least one sensor structure comprising at least one sensor element; (b) at least one passthrough defined through the sensor structure, the passthrough comprising a plurality of openings connected by a non-linear path; (c) wherein physical stimulus upon the sensor structure causes a detectable change in at least one property of the sensor structure; and (d) wherein the non-linear path is bounded by the sensor structure such that any straight-line path through the passthrough intersects the sensor structure.

According to embodiments of this presentation, the tamper-responsive passthrough module further comprises a terminal interface operationally coupled to the sensor element and configured to couple to at least one of another tamper-responsive module or an external processing circuit.

According to embodiments of this presentation, (a) the at least one sensor structure comprises a first sensor element portion and a second sensor element portion spatially separated from each other; (b) the passthrough is bounded by the first sensor element portion on a first side and by the second sensor element portion on a second side; and (c) an object traversing the passthrough must follow the non-linear path between the first and second sensor element portions.

According to embodiments of this presentation, the tamper-responsive passthrough module further comprises a sensor coupling element establishing at least one measurable property between the first sensor element portion and the second sensor element portion, wherein the sensor coupling element is positioned on an inside of the module such that accessing the coupling element from outside the module requires traversing the sensor structure, and wherein separation or displacement of the first and second sensor element portions causes a detectable change in the at least one measurable property.

According to embodiments of this presentation, the sensor coupling element comprises a plurality of spatially distributed coupling connections between the first and second sensor element portions, the spatial distribution constraining relative movement between the sensor element portions such that tilting or bending of one sensor element portion relative to the other causes a detectable change.

According to embodiments of this presentation, the sensor structure has sufficient rigidity such that deformation of the sensor structure that does not trigger the detectable change does not create an opening between the first and second sensor element portions large enough to permit bypassing the sensor structure.

According to embodiments of this presentation, the at least one sensor element is covered by at least one shielding layer.

According to embodiments of this presentation, the at least one sensor structure comprises a plurality of stacked layers, and the passthrough traverses the plurality of stacked layers via the non-linear path.

According to embodiments of this presentation, the non-linear path comprises: (a) a first passage through a first layer; (b) a lateral displacement region; and (c) a second passage through a second layer. According to embodiments of this presentation, the non-linear path comprises at least one lateral displacement having a length that is at least two times a perpendicular distance between portions of the sensor structure bounding the lateral displacement.

According to embodiments of this presentation, the sensor element comprises at least one conductive trace configured to exhibit a change in at least one electrical property upon physical stimulus. According to embodiments of this presentation, the sensor element comprises at least one of: an optical fiber or a planar optical waveguide, disposed on or within the sensor structure, configured to exhibit a change in at least one optical property upon physical stimulus.

According to embodiments of this presentation, the at least one sensor structure comprises a plurality of sensor layers alternating with layers of thermally conductive material, the layers of thermally conductive material being continuous across the sensor structure, such that a straight cut through the sensor structure necessarily intersects at least one sensor layer.

Other embodiments of this presentation include a tamper-detection system comprising: (a) at least one tamper-responsive module, each comprising at least one sensor structure comprising at least one sensor element; (b) at least one passthrough defined through the sensor structure of at least one tamper-responsive module, the passthrough comprising a plurality of openings connected by a non-linear path; (c) a processing circuit operationally coupled to the sensor structure; (d) wherein physical stimulus upon the sensor structure causes a detectable change in at least one property of the sensor structure; (e) wherein the non-linear path is bounded by the sensor structure such that any straight-line path through the passthrough intersects the sensor structure; and (f) wherein the processing circuit is configured to detect tampering based on changes in at least one measurable property of the sensor structure.

According to embodiments of this presentation, the at least one module is arranged to form a continuous perimeter enclosing a protected volume.

According to embodiments of this presentation, the tamper-detection system comprises a plurality of tamper-responsive modules coupled to form the continuous perimeter.

According to embodiments of this presentation, the plurality of coupled modules establish at least one measurable property between adjacent modules, and decoupling or displacement of adjacent modules causes a detectable change in the at least one measurable property.

According to embodiments of this presentation, the coupling between adjacent tamper-responsive modules is disposed on an interior side of the continuous perimeter facing the protected volume, such that accessing the coupling from outside the protected volume requires traversing the sensor structure of at least one tamper-responsive module.

According to embodiments of this presentation, the processing circuit is configured to periodically verify integrity of the coupling between adjacent tamper-responsive modules by measuring at least one property of a sensor path through the plurality of coupled modules, and removal or displacement of any tamper-responsive module from the continuous perimeter causes a detectable change in the measured property.

According to embodiments of this presentation, adjacent tamper-responsive modules are arranged such that the sensor structure of one module overlaps with the sensor structure of an adjacent module at their shared boundary, such that any intrusion attempt at the joint between adjacent modules must traverse at least one sensor structure.

According to embodiments of this presentation, a sensor connection between the sensor structure and the processing circuit is routed within the protected volume such that the sensor connection is inaccessible from outside the continuous perimeter without traversing at least one sensor structure.

According to embodiments of this presentation, the tamper-detection system further comprises a second continuous perimeter enclosing a second protected volume nested within the protected volume, and the second continuous perimeter comprises at least one tamper-responsive module with at least one sensor structure, wherein the processing circuit is configured to monitor the sensor structures of both the continuous perimeter and the second continuous perimeter.

According to embodiments of this presentation, at least one functional element is routed through the passthrough, selected from: (a) electrical power conductors; (b) electrical signal conductors; (c) optical signal conductors; (d) cooling fluid; (e) cooling gas; (f) thermally conductive material; or (g) mechanical fastening elements.

According to embodiments of this presentation, the processing circuit is configured to measure at least one of: resistance, capacitance, impedance, signal propagation time, signal reflection characteristics, optical attenuation, or optical signal propagation time.

According to embodiments of this presentation, the processing circuit is configured to: (a) monitor a rate of change of at least one measurable property between successive measurements; and (b) trigger a tamper event when the rate of change exceeds a configurable rate threshold.

According to embodiments of this presentation, the processing circuit is configured to trigger at least one response upon detecting tampering, selected from: (a) deletion of cryptographic keys; (b) erasure of sensitive data; (c) destruction of sensitive hardware components; or (d) generation of a tamper alert notification.

According to embodiments of this presentation, the tamper-detection system further comprises:
(a) a power management unit operationally coupled to the processing circuit; (b) an internal battery disposed within the protected volume, the internal battery providing sufficient energy to complete zeroization of cryptographic keys and sensitive data; and (c) at least one external battery disposed outside the protected volume.

According to embodiments of this presentation, the tamper-detection system comprises at least two external batteries connected in parallel via the power management unit, wherein any single external battery is removable and replaceable without interrupting power to the processing circuit.

Other embodiments of this presentation include a method of providing tamper-detected access through a tamper-detection module, the method comprising: (a) providing a sensor structure having at least one measurable property; (b) defining a passthrough through the sensor structure, wherein the passthrough follows a non-linear path bounded by the sensor structure; (c) routing at least one functional element through the passthrough along the non-linear path; and (d) monitoring the measurable property to detect physical manipulation of the sensor structure.

According to embodiments of this presentation, the method further comprises triggering a tamper event when at least one of: (a) a deviation between a current value and a reference value exceeds a configurable tolerance; or (b) a rate of change of the measurable property between successive measurements exceeds a configurable rate threshold.

Other embodiments of this presentation include a tamper-responsive passthrough module that comprises at least one sensor structure having at least one sensor element and at least one passthrough defined through the sensor structure. The passthrough comprises a plurality of openings connected by a non-linear path bounded by the sensor structure, such that any straight-line path through the passthrough intersects the sensor structure. A plurality of modules may be coupled to form a continuous perimeter enclosing a protected volume. A processing circuit monitors measurable properties of the sensor structure to detect tampering. Functional elements including electrical power conductors, signal conductors, optical conductors, cooling fluid, cooling gas, thermally conductive material, and mechanical fastening elements may be routed through the passthrough along the non-linear path. The system enables comprehensive tamper detection while maintaining operational access to a protected device.

### BRIEF DESCRIPTION OF THE DRAWINGS

FIG. 1 is a schematic diagram showing a three-dimensional exploded view of a tamper-detection system according to an illustrative embodiment.

FIG. 2 is a schematic diagram showing a three-dimensional exploded view and a non-exploded detail view of a tamper-responsive module with filament passthrough interface according to an illustrative embodiment.

FIG. 3 is a block diagram of a tamper-detection system showing a continuous perimeter, processing circuit, signal converter, power management unit, and associated components according to an illustrative embodiment.

FIG. 4 is a block diagram showing a tamper-detection system with a tamper-responsive passthrough module, a tamper-responsive module without passthrough, and an intrusion attempt according to an illustrative embodiment.

FIG. 5 is a section view of a tamper-responsive module with air passthrough interface according to an illustrative embodiment.

FIG. 6 is a section view of a tamper-responsive module with structural passthrough interface according to an illustrative embodiment.

FIG. 7 is a three-dimensional schematic diagram showing the interior of a cube formed by a plurality of interlocked sensor structures according to an illustrative embodiment.

FIG. 8 is a cross-section diagram showing interlocked outer and inner sensor structures with a recess joint according to an illustrative embodiment.

FIG. 9 is a schematic diagram of a trace layout within a sensor element according to an illustrative embodiment.

FIG. 10 is a flow diagram of a tamper detection process according to an illustrative embodiment.

FIG. 11 is a schematic diagram of a tamper-responsive module with fluid passthrough interface showing sensor structures, a non-linear fluid path, mounting brackets, and fastening elements according to an illustrative embodiment.

FIG. 12 is a schematic diagram of the cross-section of a tamper-responsive passthrough module with a plurality of stacked sensor elements and openings connected by non-linear paths according to an illustrative embodiment.

FIG. 13 is a schematic diagram of the cross-section of a tamper-responsive passthrough module with elements of high thermal conductivity disposed between sensor layers according to an illustrative embodiment.

FIG. 14 is a schematic diagram of a tamper-responsive passthrough module with a fluid channel routed via non-linear paths according to an illustrative embodiment.

FIG. 15 is a schematic diagram of an unfolded flexible printed circuit board forming a sensor structure with bending lines according to an illustrative embodiment.

FIG. 16 is a schematic diagram of a folded flexible printed circuit board forming a corner structure according to an illustrative embodiment.

FIG. 17 is a block diagram of a tamper-detection system with a shielding perimeter, shielding passthroughs, and passthroughs according to an illustrative embodiment.

FIG. 18 is a block diagram of a tamper-detection system with nested protected volumes according to an illustrative embodiment.

FIG. 19 is a cross-section view of a tamper-responsive passthrough module showing spatially distributed sensor coupling elements according to an illustrative embodiment.

### DESCRIPTION OF THE INVENTION

The present invention is described herein with reference to illustrative embodiments for particular applications. It should be understood that the invention is not limited thereto. Those having ordinary skill in the art and access to the teachings provided herein will recognize additional modifications, applications, and embodiments within the scope thereof and additional fields in which the present invention would be of significant utility. Illustrative embodiments and exemplary applications will now be described with reference to the accompanying drawings to disclose the advantageous teachings of the present invention.

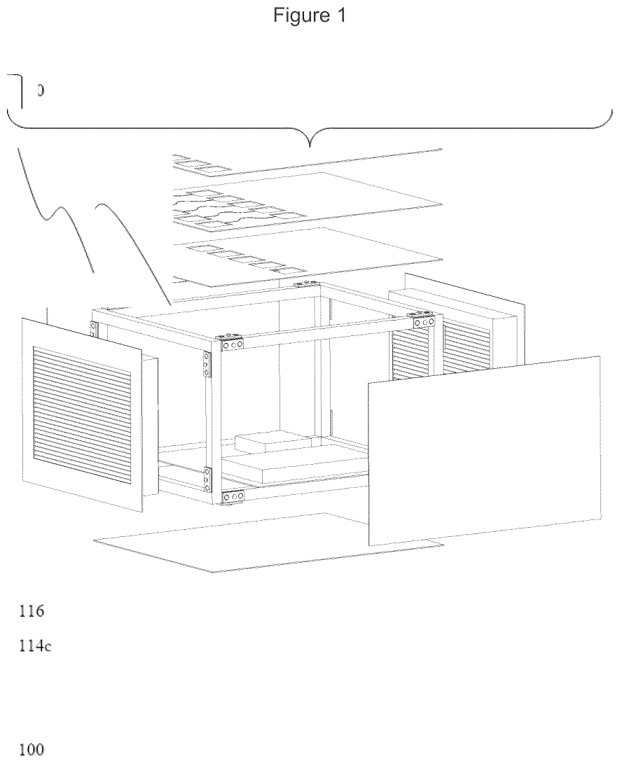

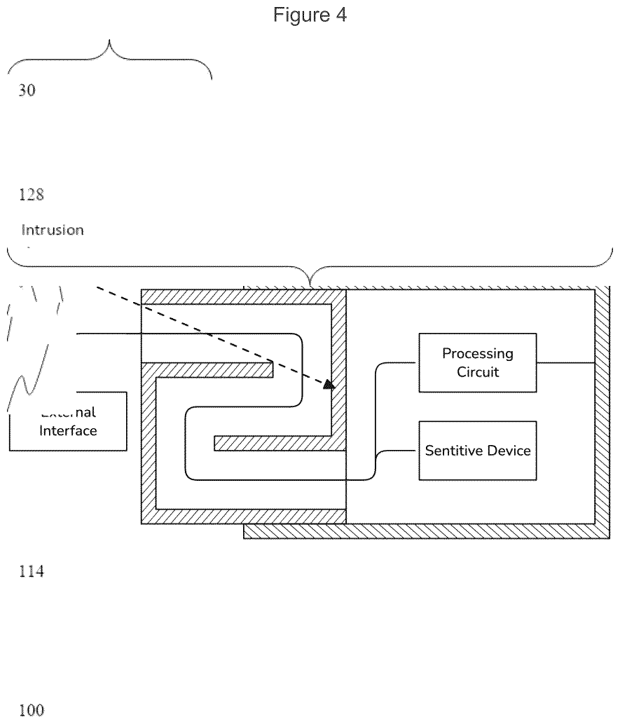

Referring to FIGS. 1 and 4, the invention provides a tamper-responsive passthrough module 10 as a modular building block for tamper-detection systems 100. The module 10 comprises at least one sensor structure 12 comprising at least one sensor element 14, and at least one passthrough 30 defined through the sensor structure 12. The passthrough 30 comprises a plurality of openings 16 connected by a non-linear path 18. Physical stimulus upon the sensor structure 12 causes a detectable change in at least one property of the sensor structure 12. The non-linear path 18 is bounded by the sensor structure 12 such that any straight-line path through the passthrough 30 intersects the sensor structure 12. This geometry prevents an attacker from bypassing tamper detection by creating a straight path through the module 10, as illustrated in FIG. 4.

The sensor structure 12 is a physical structure comprising at least one sensor element 14. In a preferred embodiment, the sensor structure 12 comprises a substrate 26 and a sensor element 14 disposed on or within the substrate 26. The substrate 26 may be a rigid printed circuit board (such as fiberglass-reinforced epoxy laminate, e.g., FR-4), a flexible printed circuit board (such as polyimide), glass, ceramic, or polymer. The sensor element 14 may comprise conductive traces, optical fibers, planar optical waveguides, or other elements configured to exhibit a detectable change in response to physical stimulus. In a preferred embodiment, the sensor structure 12 is a printed circuit board with conductive traces forming the sensor element 14, where the PCB substrate 26 serves as the structural component and the copper traces serve as the sensor element 14.

The passthrough 30 is defined through the sensor structure 12, comprising a plurality of openings 16 connected by the non-linear path 18. At least one opening 16 is accessible from outside the module 10 and at least one opening 16 is accessible from inside the module 10, such that functional elements may be routed from outside the module 10, through the sensor structure 12, to inside the module 10. The non-linear path 18 is bounded by the sensor structure 12 such that any straight-line path through the passthrough 30 intersects the sensor structure 12. The non-linear path 18 geometry prevents straight-line penetration through the module 10. Any attempt to create a straight path through the module 10 would necessarily intersect the sensor structure 12, causing a detectable change. For example, an elongated rigid object, such as a probe or drill bit, cannot be inserted through the passthrough 30 in a straight line without intersecting the sensor structure 12.

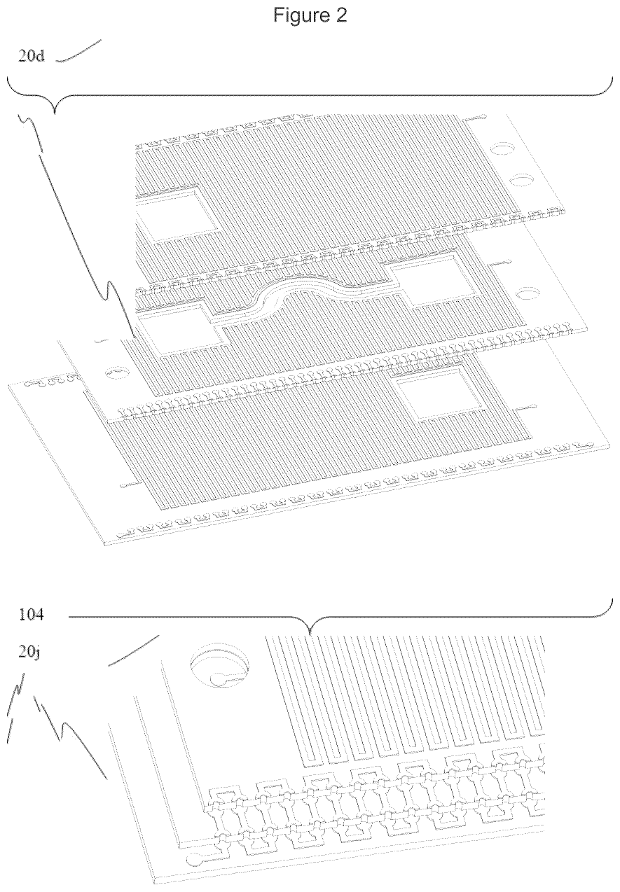

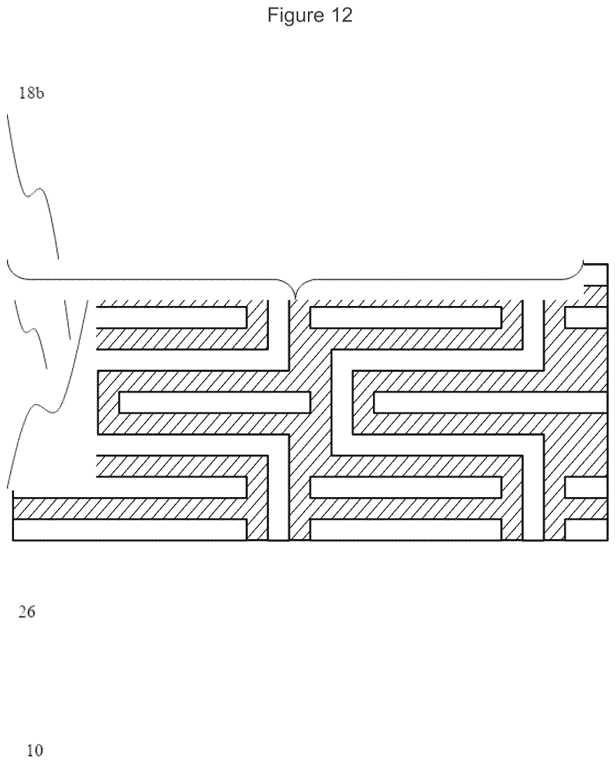

Referring to FIGS. 2 and 12, in a preferred embodiment the sensor structure 12 comprises a plurality of stacked layers, and the passthrough 30 traverses the plurality of stacked layers via the non-linear path 18. The non-linear path 18 may comprise a first passage through a first layer, a lateral displacement region, and a second passage through a second layer. Further lateral movements and passages through additional layers may be repeated as needed. In a preferred variant, the non-linear path 18 comprises at least two changes in direction. The plurality of stacked layers may comprise a plurality of rigid printed circuit boards. The length required for lateral displacement depends on the distance between the stacked layers. In a preferred variant, the length of lateral displacement is at least two times, and preferably at least five times, the distance between the stacked layers. If the available space for lateral movement is limited, such as when a ball grid array connector constrains the available area, traces may execute multiple lateral movements across multiple layers. Alternatively, the lateral movements of individual traces may be distributed across different layers, enabling a longer lateral displacement for each trace, as shown in FIG. 12.

In the stacked-layer embodiment, the non-linear path 18 geometry is structurally defined by the positions of the openings 16 in each layer and by the physical arrangement of the layers relative to each other. The path geometry is inherent to the manufactured components rather than dependent on assembly procedures. This ensures consistent tamper-detection coverage regardless of assembly variations.

In another embodiment, the non-linear path 18 comprises a labyrinthine or tortuous channel within a monolithic or multi-part sensor structure 12. The channel includes multiple changes of direction in three dimensions, including turns in the X, Y, and Z axes. This geometry increases the difficulty of navigating the passthrough 30 with any rigid probing instrument and provides multiple independent sensor element 14 intersections along the path. The labyrinthine path may be formed by milling, drilling, 3D printing channels within a substrate 26 that is subsequently populated with sensor elements 14, or by stacking multiple printed circuit boards with offset openings.

In another embodiment, the sensor structure 12 is fabricated using additive manufacturing processes. A dielectric substrate 26 is formed by 3D printing (such as stereolithography, fused deposition modeling, or multi-jet printing), and conductive traces forming the sensor element 14 are deposited using conductive ink deposition, aerosol jet printing, or embedded wire techniques during or after the printing process. Additive manufacturing enables the creation of complex three-dimensional non-linear path 18 geometries, including overhanging internal channels and interlocking internal structures, that are difficult or impossible to achieve with stacked planar layers. The passthrough 30 may be formed as an integral part of the 3D-printed structure, with the non-linear path geometry embedded within the printed volume.

In a preferred embodiment, the sensor element 14 comprises a first sensor element portion and a second sensor element portion spatially separated from each other. The passthrough 30 is bounded by the first sensor element portion on a first side and by the second sensor element portion on a second side. An object traversing the passthrough 30 must follow the non-linear path 18 between the first and second sensor element portions.

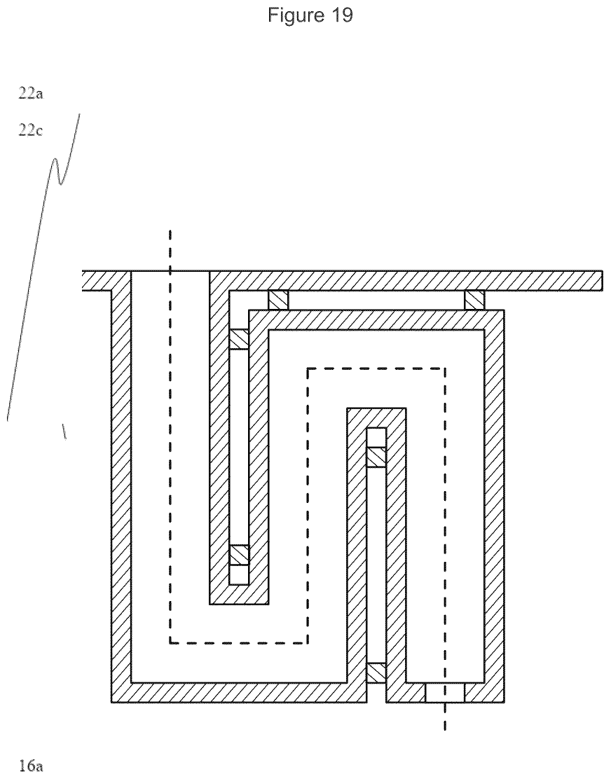

Referring to FIGS. 2 and 19, a sensor coupling element 22 may connect the first sensor element portion to the second sensor element portion. Separation of the first and second sensor element portions causes a detectable change. The sensor coupling element 22 may be positioned on an inside of the module 10 such that accessing the coupling element 22 from outside the module 10 requires traversing the sensor structure 12.

In a further embodiment, the sensor coupling element 22 comprises a plurality of spatially distributed coupling connections between the first and second sensor element portions. This spatial distribution constrains relative movement between the sensor element portions, preventing tilting or bending that could create an undetected intrusion path. In a preferred variant, the first and second sensor element portions comprise flexible printed circuit boards, enabling the sensor structure 12 to conform to the geometry of the passthrough 30 and to wrap around the non-linear path 18. The sensor coupling elements 22 comprise solder joints between conductive pads of the first sensor element portion and corresponding conductive pads of the second sensor element portion. The solder joints form permanent connections that cannot be separated without causing visible damage and a detectable change in at least one measurable property of the sensor circuit.

In a preferred embodiment, the sensor structure 12 has sufficient rigidity such that any deformation of the sensor structure 12 that does not trigger a detectable change in the sensor element 14 does not create an opening between the first and second sensor element portions large enough to permit an object to bypass the sensor structure 12. The combination of the spatially distributed coupling connections and the structural rigidity of the sensor structure 12 ensures that any deformation large enough to create an exploitable gap necessarily exceeds the detection threshold, while deformation below the detection threshold is geometrically insufficient to provide a path around the sensor structure 12.

The module 10 may include a terminal interface 20 operationally coupled to the sensor element 14 and configured to couple to at least one of another sensor structure 12, another tamper-responsive module, or an external processing circuit 202. When multiple modules are coupled via their terminal interfaces, a continuous sensor path may be created. Decoupling modules interrupts this path, causing a detectable change. The coupling via terminal interfaces may be configured to maintain a measurable property through a limited range of displacement while causing a detectable change when displacement exceeds the limited range. This enables tolerance for thermal expansion and assembly variation while detecting tampering attempts.

The terminal interface may comprise a compliant element that maintains contact pressure through the limited range of displacement. In various embodiments, the compliant element may comprise spring-loaded contacts such as pogo pins, flexible conductive material, or a compliant sheet pressed against contact surfaces. These configurations accommodate normal operational variations while ensuring that unauthorized displacement or removal triggers detection.

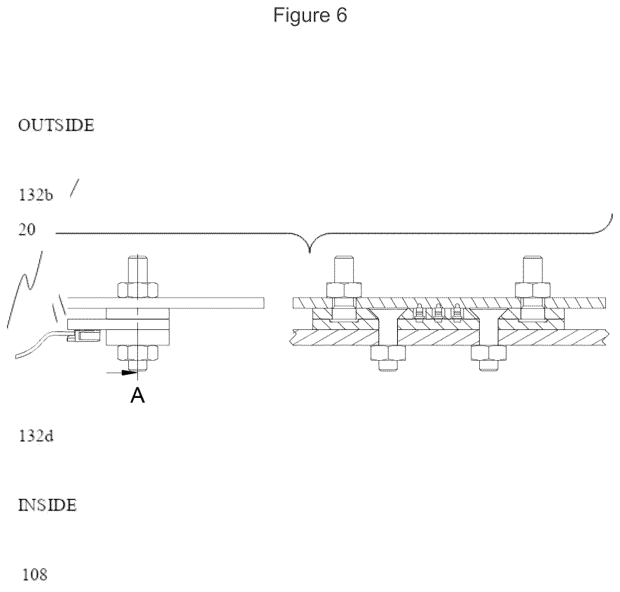

Referring to FIG. 6, in one embodiment the terminal interface comprises spring-loaded contact pins (pogo pins) soldered to an inner sensor structure 12b and contacting the terminal interface 20 on an outer sensor structure 12a. In another embodiment, the conductive traces of different modules are connected by soldering. In another variant, an elastically deformable part such as a rubber gasket is used. A support structure generates a deformation of the elastically deformable part. The conductive traces in the individual modules form conductive surfaces located on the outer surfaces of each module. The structure is arranged such that the elastic force of the deformable part creates a constant contact pressure between the conductive surfaces of a plurality of modules. In another variant, conductive traces on different layers within a single printed circuit board are connected through vias.

The sensor coupling element 22 or terminal interface 20 may employ various coupling methods to couple sensor elements 14 between adjacent sensor structures 12 or between stacked layers within a module 10. These coupling methods may be categorized as permanent connections, disassemblable connections, or non-contact couplings.

Permanent connections include: vias connecting conductive traces across multiple layers within a single printed circuit board; soldering through castellated holes, wherein a first sensor structure 12 has castellated vias at its edge and a second sensor structure 12 has corresponding solder pads, enabling a permanent solder joint between the two sensor structures 12; direct soldering of printed circuit board pads between adjacent sensor structures 12; or deposition of conductive material bridging conductive traces on adjacent sensor structures 12, such as through electroless plating, sputtering, or conductive adhesive.

Disassemblable connections include: spring-loaded contact pins (pogo pins) that maintain contact pressure against a terminal interface 20 or contact pads; elastomeric connectors comprising alternating layers of conductive and non-conductive elastomeric material, which provide a plurality of parallel electrical connections when compressed between two sensor structures 12; conductive wires bonded between connection pads; spring contacts such as cantilever springs or dome contacts; or compressible conductive gaskets.

Non-contact couplings include: capacitive coupling, wherein conductive elements of a first sensor element portion and conductive elements of a second sensor element portion are disposed in proximity to each other such that a capacitance is established between them, and separation or displacement of the sensor element portions changes the capacitance; inductive coupling, wherein a coil or loop in one sensor element portion is inductively coupled to a coil or loop in another sensor element portion, and separation or displacement changes the mutual inductance; or optical coupling, wherein an optical emitter in one sensor element portion is aligned with an optical receiver in another sensor element portion, and displacement disrupts the optical path.

Permanent connections provide higher tamper resistance, as they cannot be separated without causing visible damage or a detectable change in the sensor circuit. Disassemblable connections enable field serviceability and the routing of functional elements 128 with pre-terminated connectors as described herein, and provide tamper detection through monitoring of measurable properties across the connection. Non-contact couplings enable tamper detection without requiring physical connections between sensor element portions and may be combined with contact-based connections to provide redundant detection mechanisms.

In another embodiment, the sensor structure 12, the sensor coupling element 22, or both, may be encased in an opaque encapsulant 150 such as epoxy resin. The encapsulant provides additional resistance to physical access and visual inspection of the sensor element 14 layout, and any attempt to remove the encapsulant causes physical disturbance to the sensor structure 12, resulting in a detectable change.

Referring to FIG. 4, a tamper-detection system 100 comprises at least one tamper-responsive module comprising at least one sensor structure 12 with at least one sensor element 14, and a processing circuit 202 operationally coupled to the sensor structure 12 via a sensor connection 130. At least one tamper-responsive module further comprises at least one passthrough 30 defined through the sensor structure 12. The processing circuit 202 is configured to detect tampering based on changes in at least one measurable property of the sensor structure 12. The processing circuit 202 may be a microprocessor, a microcontroller, a digital signal processor, a field-programmable gate array, or a programmable logic device, preferably a microprocessor.

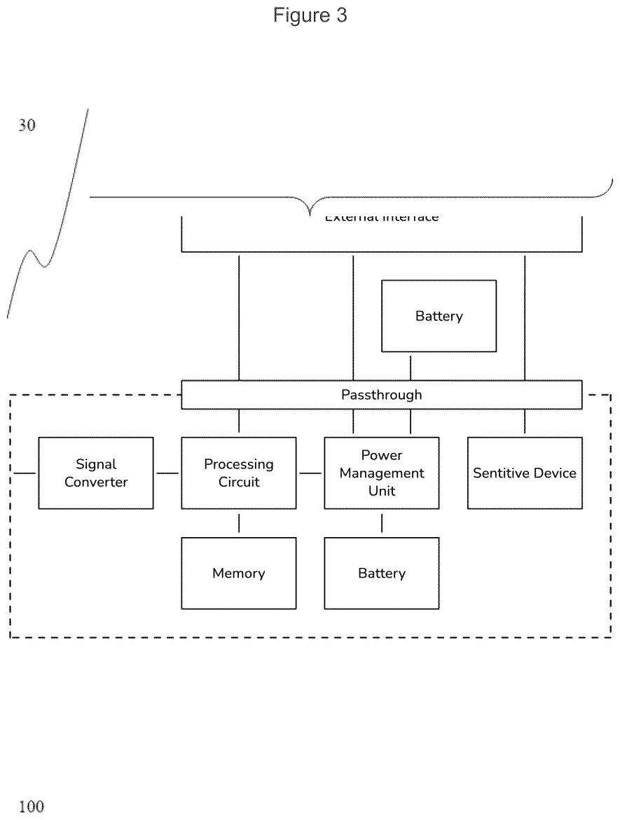

Referring to FIGS. 1 and 3, in a preferred embodiment the at least one module is arranged to form a continuous perimeter 122 enclosing a protected volume 124. A plurality of tamper-responsive modules may be coupled to form the continuous perimeter 122. The continuous perimeter 122 may include tamper-responsive modules with passthroughs, such as a tamper-responsive module with filament passthrough interface 104, a tamper-responsive module with air passthrough interface 106, a tamper-responsive module with structural passthrough interface 108, a tamper-responsive module with fluid passthrough interface 110, or a tamper-responsive module with thermal conduction passthrough interface 112, as well as tamper-responsive modules without passthroughs 114. Coupling the plurality of modules creates a continuous sensor path, and interruption of the continuous sensor path causes a detectable change.

In a preferred embodiment, the continuous perimeter 122 comprises a combination of rigid and flexible modules. Rigid tamper-responsive modules are utilized for planar surfaces to provide structural rigidity, while flexible tamper-responsive modules are utilized to cover edges and corners. The flexible modules may be connected to the rigid modules via the terminal interfaces 20 described herein.

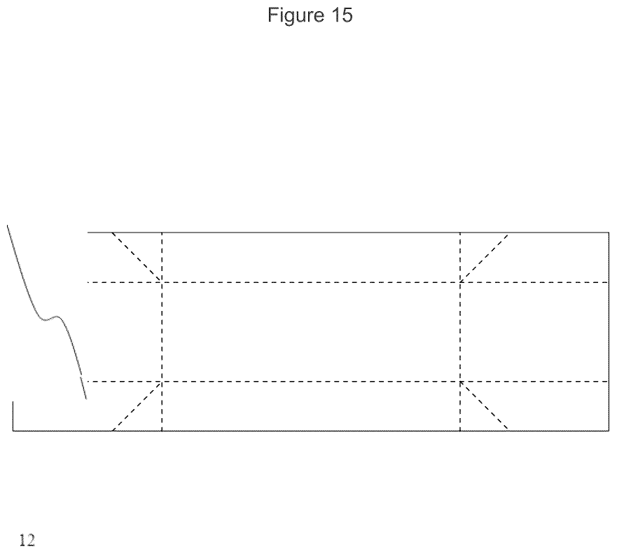

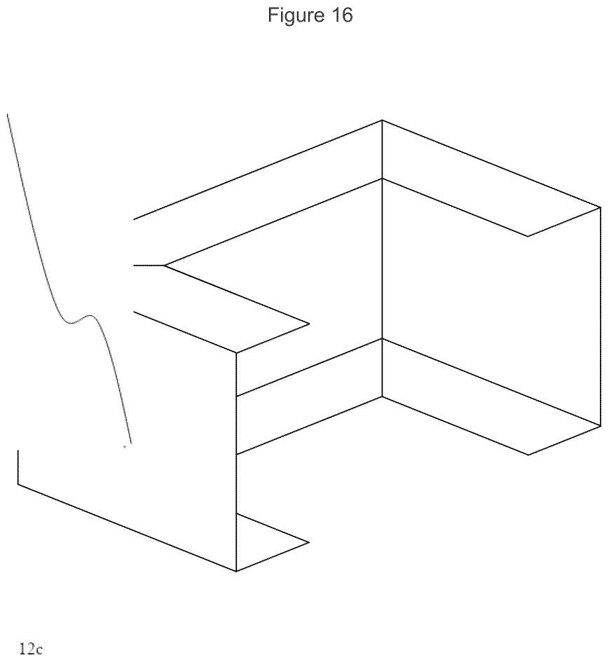

Continuous coverage at edges and corners may be achieved by folding a flexible printed circuit board along bending lines to form a continuous surface covering side, top, and bottom surfaces with no gaps between adjacent surfaces, at edges, or at corners. Referring to FIG. 15, a sensor structure 12 comprising a flexible printed circuit board is provided with defined bending lines 28a, 28b, and 28c. Referring to FIG. 16, the board is folded along these bending lines to form a three-dimensional corner structure covering a top surface 12a, a bottom surface 12b, and a side surface 12c, ensuring that the corner intersection is fully enclosed by the sensor structure 12.

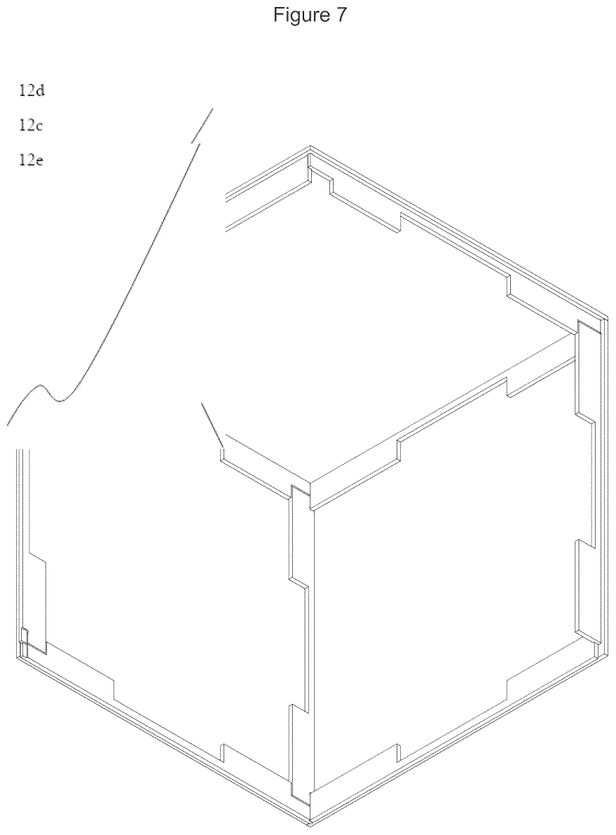

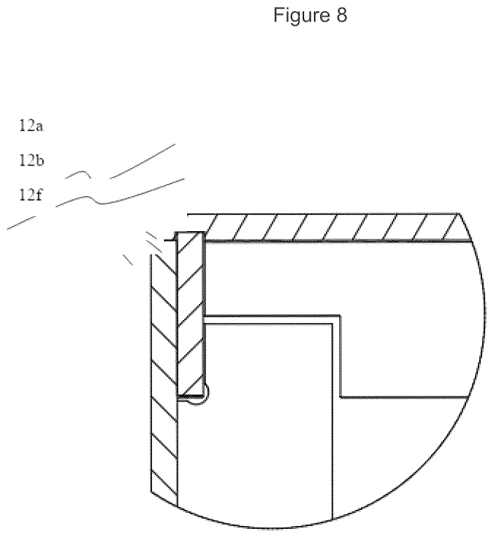

Referring to FIGS. 7 and 8, in an alternative embodiment for protecting corners and edges using rigid sensor structures, a plurality of rigid printed circuit boards are arranged in a stacked or overlapping configuration. The edges of the rigid boards may be stepped, rabbeted, or interlocked such that the sensor structure 12 of a first board overlaps with the sensor structure 12 of a second board at the corner joint. This stacking ensures that any straight-line path through the corner joint intersects at least one sensor element 14. In a preferred variant, a plurality of outer sensor structures 12 form the outer planar surfaces, and a plurality of inner sensor structures 12 are disposed perpendicular to the outer sensor structures at the edges. The inner sensor structures interlock with the outer sensor structures and with each other. The inner sensor structures may be made from the same materials as the outer sensor structures, such as printed circuit boards or other planar substrates. A recess, such as a half-depth milled slot, may be formed in an outer sensor structure 12 to receive an inner sensor structure 12, providing an interlocking joint. The inner sensor structures close gaps at edges and corners that arise from manufacturing tolerances, ensuring that any path from outside to inside the arrangement passes through a non-linear path bounded by sensor structures.

In another embodiment, adjacent tamper-responsive modules are configured to form a distributed capacitive sensor at their shared boundaries. Conductive elements on the facing surfaces of adjacent modules form capacitor plates, and the processing circuit 202 monitors the capacitance between these plates. Displacement, separation, or insertion of foreign material between adjacent modules alters the measured capacitance, providing an additional detection mechanism at module joints that is independent of the terminal interface 20 connections. This capacitive proximity sensing provides continuous analog monitoring of the spatial relationship between modules and may be combined with the continuity check provided by the terminal interface 20 to provide complementary detection mechanisms.

A support frame 120 may be provided to mechanically receive and retain the modules. The support frame 120 may define the geometry of the protected volume 124. In one embodiment, the support frame 120 is constructed from T-slotted aluminum profiles. Referring to FIG. 6, a tamper-responsive module with structural passthrough interface 108 may be mounted to the support frame 120 using fastening elements 132 and a mounting bracket 134. The sensor structure 12 may be held in place by structural elements on both the inside and outside, with the sensor structure 12 clamped between them. The fastening elements 132 may comprise clinched threaded studs, countersunk screws, or clinched studs. In particular, countersunk screws on the inside of the module may be replaced with clinched studs.

In another embodiment, the support frame 120 comprises modular frame segments that may be assembled in different configurations to define protected volumes 124 of different sizes and shapes. The tamper-responsive modules are sized to correspond to the modular frame segments, enabling the same set of module designs to be used for different enclosure sizes. The terminal interfaces 20 accommodate the different configurations. For example, a first deployment may use a small enclosure protecting a single sensitive device 116, while a second deployment uses a larger enclosure protecting an entire server rack. Standard module dimensions enable inventory of a limited number of module types that can be combined to meet diverse deployment requirements.

In another embodiment, the tamper-detection system 100 comprises an inner support frame disposed within the protected volume 124 and an outer support frame disposed outside the protected volume 124. The tamper-responsive modules forming the continuous perimeter 122 are disposed between the inner support frame and the outer support frame. The inner support frame, the outer support frame, and optionally additional positioning elements such as spacers, gaskets, or alignment features, cooperate to constrain the positions of the tamper-responsive modules such that the modules form the continuous perimeter 122. In this configuration, the tamper-responsive modules are not individually fastened to a single support frame; rather, their positions are defined by the combined geometry of the inner support frame, the outer support frame, and any intermediate elements. The inner and outer support frames may be coupled to each other through or around the continuous perimeter 122, and the coupling force between the inner and outer support frames maintains the tamper-responsive modules in their constrained positions. Releasing the coupling between the inner and outer support frames enables access to the tamper-responsive modules for assembly, maintenance, or replacement. The coupling between the inner and outer support frames may be monitored by the processing circuit 202, such that separation of the frames beyond a predetermined threshold causes a detectable change.

The protected volume 124 may contain one or more sensitive devices 116. The sensitive device 116 may comprise a cryptographic hardware security module, a secure data storage unit, a graphics processing unit, an AI accelerator, or a processing circuit containing cryptographic keys. In other embodiments, the protected volume 124 may contain non-electronic assets requiring high-security protection, such as pharmaceuticals, biological samples, forensic evidence, precious metals, or important documents. The protected volume 124 may also contain auxiliary components such as network switches, USB-over-IP devices, power distribution units, power supplies, or other electronic equipment. Power and data connections to such auxiliary components may be routed through the passthrough 30 of the tamper-responsive modules as functional elements 128.

In a preferred embodiment, the number of functional elements 128 routed through the continuous perimeter 122 is minimized by disposing distribution components within the protected volume 124. A single power connection or a small number of power connections may be routed through the passthrough 30 to a power distribution unit 154 or power supply disposed within the protected volume 124, which then distributes power to a plurality of sensitive devices 116 and auxiliary components within the protected volume 124. Similarly, a single data connection or a small number of data connections may be routed from an external network 148, through the passthrough 30, to a network switch 152 disposed within the protected volume 124, which then distributes data to a plurality of devices within the protected volume 124. By minimizing the number of functional elements 128 that traverse the continuous perimeter 122, the number of passthroughs 30 required is reduced, thereby reducing the number of potential intrusion paths through the continuous perimeter 122 and simplifying the overall system design.

In another embodiment, the processing circuit 202 is enclosed within a second protected volume separate from a first protected volume. The first and second protected volumes are independently accessible, such that opening either one does not compromise tamper detection of the other. This enables servicing the contents of the first protected volume without compromising the cryptographic keys or attestation capability maintained by the processing circuit 202 in the second protected volume.

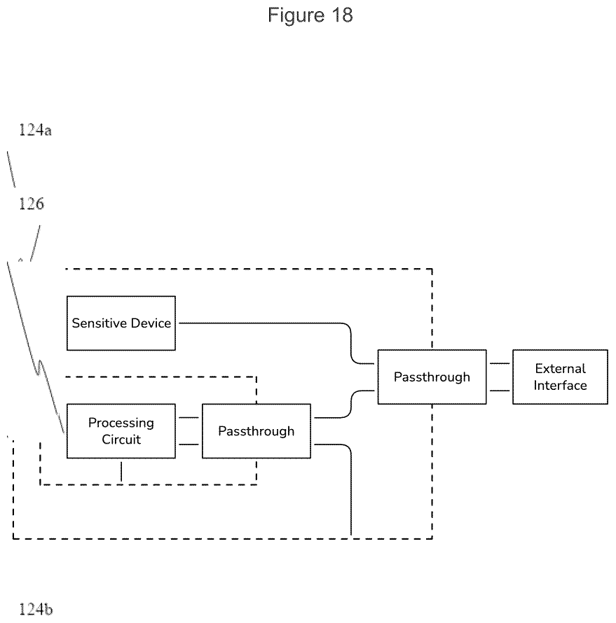

Referring to FIG. 18, in another embodiment, the tamper-detection system 100 comprises a first protected volume 124a enclosed by a first continuous perimeter 122a, and a second protected volume 124b enclosed by a second continuous perimeter 122b nested within the first protected volume 124a. The sensitive device 116 is disposed within the first protected volume 124a and outside the second continuous perimeter 122b. The processing circuit 202 is disposed within the second protected volume 124b. The second continuous perimeter 122b provides an additional layer of tamper detection around the most sensitive components, such as cryptographic keys or the processing circuit 202 itself. A passthrough 30a is defined through the first continuous perimeter 122a, connecting the first protected volume 124a to an external interface 126 disposed outside the first continuous perimeter 122a. A passthrough 30b is defined through the second continuous perimeter 122b. The sensitive device 116 is connected to the external interface 126 through passthrough 30a. The processing circuit 202 is connected through passthrough 30b to passthrough 30a and then to the external interface 126. A sensor connection 130a couples the processing circuit 202 to the first continuous perimeter 122a for monitoring the sensor structures of the first continuous perimeter 122a. The sensor connection 130a is routed from the processing circuit 202, through passthrough 30b at the boundary of the second continuous perimeter 122b, into the first protected volume 124a, and to the first continuous perimeter 122a. A sensor connection 130b couples the processing circuit 202 to the second continuous perimeter 122b for monitoring the sensor structures of the second continuous perimeter 122b. The first and second continuous perimeters 122a and 122b may be monitored by the same processing circuit 202 or by independent processing circuits. This nested arrangement provides defense in depth, requiring an attacker to defeat two independent tamper-detection perimeters to access the innermost assets.

The sensor connection 130 between the sensor structure 12 and the processing circuit 202 is routed within the protected volume 124 such that the sensor connection 130 is inaccessible from outside the continuous perimeter 122 without traversing at least one sensor structure 12. In the embodiment with nested protected volumes shown in FIG. 18, the sensor connection 130a from the processing circuit 202 to the first continuous perimeter 122a traverses the passthrough 30b of the second continuous perimeter 122b and is routed within the first protected volume 124a, ensuring that the sensor connection 130a is inaccessible from outside the first continuous perimeter 122a without traversing at least one sensor structure. In a preferred embodiment, the sensor connection 130 itself forms part of the sensor element 14, such that severing or modifying the sensor connection 130 causes a detectable change in at least one measurable property. For example, the sensor connection 130 may comprise conductive traces whose resistance or signal propagation time is monitored by the processing circuit 202, such that cutting, splicing, or otherwise tampering with the sensor connection 130 is detected. The combination of physical inaccessibility within the protected volume 124 and incorporation into the sensor circuit prevents an attacker from intercepting or manipulating signals between the sensor structure 12 and the processing circuit 202.

The passthrough 30 may be configured to accommodate various functional elements 128 depending on the application. These include: electrical power conductors for delivering power to components within the protected volume 124; electrical signal conductors such as controlled-impedance traces for high-speed data signals; optical signal conductors such as fiber optic cables; cooling fluid such as water or other coolant routed through liquid cooling channels; cooling gas routed through air cooling pathways; thermally conductive material for conductive cooling such as copper or other high-thermal-conductivity materials forming a continuous thermal path; or mechanical fastening elements such as screws, threaded studs, or mounting brackets. Gaskets may be provided within the passthrough 30 to form sealed fluid channels.

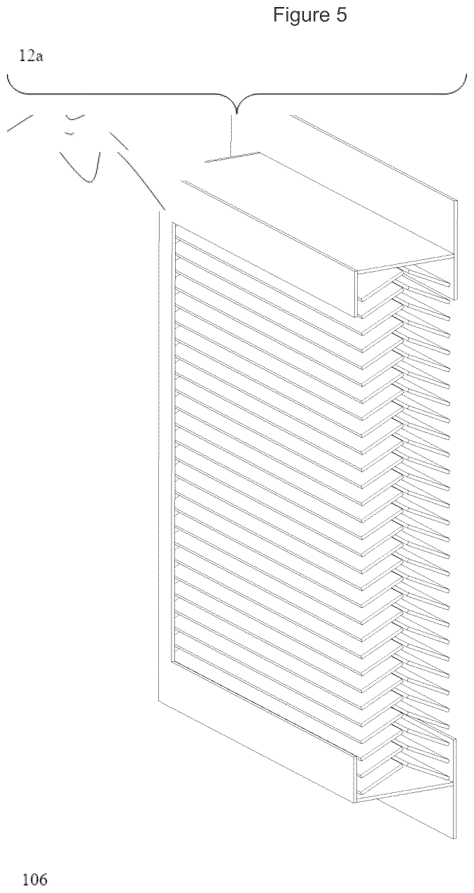

Different module types may be configured for different functional elements 128. For example, a tamper-responsive module with filament passthrough interface 104 may route electrical or optical conductors, a tamper-responsive module with air passthrough interface 106 may provide air cooling pathways as shown in FIG. 5, a tamper-responsive module with structural passthrough interface 108 may accommodate mechanical fastening elements and structural connections between the support frame 120 and external mounting structures, and a tamper-responsive module with fluid passthrough interface 110 may route liquid coolant.

In a preferred embodiment, the passthrough 30 provides a generic channel that is independent of the specific functional element 128 to be routed through it. The passthrough 30 geometry defines the tamper-detection boundary, while the choice of which functional element 128 to route through the passthrough 30 may be made by the end user at the time of deployment. This enables a single passthrough module design to serve multiple applications without modification to the module 10 itself. For example, the same tamper-responsive module with filament passthrough interface 104 may route electrical power conductors in one deployment and optical signal conductors in another deployment, depending on the requirements of the specific sensitive device 116 being protected.

In an embodiment where the sensor structure 12 comprises a plurality of stacked layers, the module 10 is configured to be disassembled into individual layers and reassembled after routing functional elements 128 through the passthrough 30. This enables the routing of cables with pre-terminated connectors having a cross-section larger than the cross-section of the non-linear path 18 through the assembled module 10. During installation, the stacked layers are separated, a connector at one end of the cable is passed through an opening 16 in an individual layer, the cable is threaded along the non-linear path 18 across the layers as they are progressively reassembled, and the module 10 is then fully reassembled with the sensor coupling elements 22 or terminal interfaces reestablishing the sensor circuit. This enables the use of standard pre-terminated cables and connectors without requiring custom cable fabrication or in-situ termination within the protected volume 124.

In a preferred embodiment, the sensor element 14 comprises at least one conductive trace configured to exhibit a change in at least one electrical property upon physical stimulus. The conductive trace may be disposed on a substrate 26 comprising at least one of: a rigid printed circuit board (such as fiberglass-reinforced epoxy laminate, e.g., FR-4), a flexible printed circuit board (such as polyimide), glass, ceramic, or polymer. The conductive trace may comprise at least one of: copper, silver, tin, or other electrically conductive material.

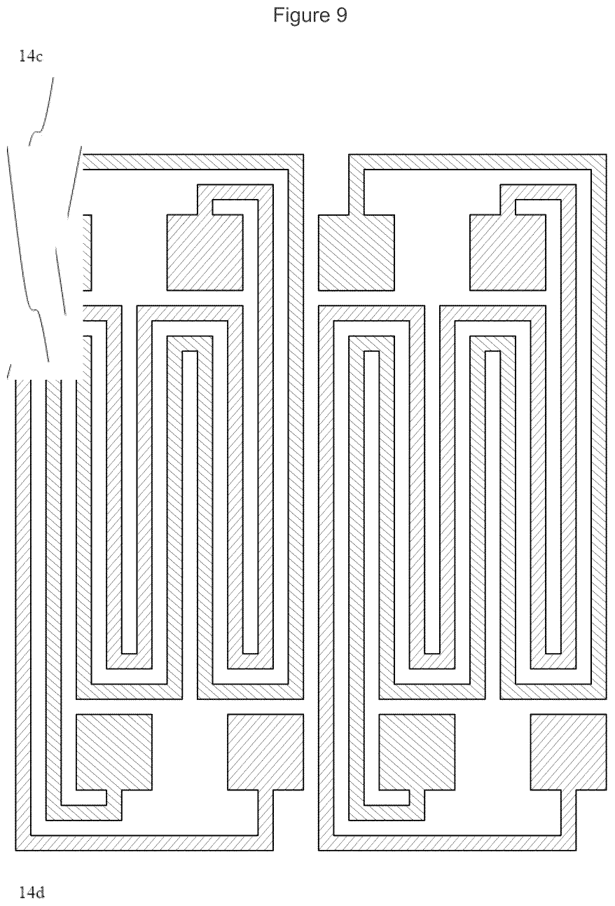

Referring to FIG. 9, the conductive traces may be arranged in a meandering shape within the sensor structure 12. A plurality of sensor elements 14 may be disposed in the same plane with their conductive traces interleaving. The conductive traces may be arranged so that two conductive traces of adjacent sensor elements form a pair and are routed in parallel to each other in close proximity. This interleaving arrangement enables contactless coupling between the sensor elements, such as capacitive coupling, and enables differential measurement: instead of measuring a property of each trace independently, only the difference of the property between the two paired traces is measured. In a preferred variant, the differential is calculated in the analog domain to achieve higher digital measurement resolution.

The density of the sensor element 14 within the sensor structure 12 influences the minimum feature size that can pass between sensor elements undetected. The sensor element 14, whether comprising conductive traces, optical fibers, optical waveguides, or other sensing elements, is arranged with a characteristic width and spacing. In a preferred variant using conductive traces on a printed circuit board, the traces have a width of approximately 100 μm and a spacing of approximately 100 μm, resulting in a pitch of approximately 200 μm. At this density, a physical intrusion tool or probe with a cross-section exceeding the spacing in any orientation intersects at least one sensor element 14. Smaller widths and spacings, for example 50 μm or less, may be used where finer detection granularity is required. Larger widths and spacings may be used depending on the application requirements. The sensor element density may vary across different regions of the sensor structure 12, with higher density in regions adjacent to the passthrough 30 and lower density in regions further from potential intrusion paths.

The sensor structure 12 may comprise multiple sensor layers, where each sensor layer contains one or more conductive traces forming the sensor element 14. One or more sensor layers may be combined with further elements, such as one or more shielding layers 24 or dielectric layers, to form the complete sensor structure 12. In one variant, the sensor layers are layers within a single printed circuit board. In another variant, the sensor layers are in separate printed circuit boards placed in direct contact, with conductive traces on different boards connected to each other. In another variant, the sensor layers are in separate printed circuit boards with a gap between them, and the gap is bridged by a connector or another printed circuit board.

In another embodiment, the sensor structure 12 comprises redundant sensor paths, wherein each region of the sensor structure 12 is covered by at least two independent sensor elements 14. The processing circuit 202 monitors each sensor path independently. If one sensor path is compromised (for example, by environmental damage rather than intentional tampering), the processing circuit 202 may continue to provide tamper detection using the remaining sensor path or paths while generating an alert indicating degraded coverage. The redundant paths may use different sensing modalities—for example, a first path using conductive traces monitored for resistance and a second path using conductive traces monitored for capacitance-such that an attack capable of defeating one sensing modality does not simultaneously defeat the other.

In another embodiment, the sensor element 14 comprises at least one optical fiber disposed on or within the sensor structure 12, configured to exhibit a change in at least one optical property upon physical stimulus. The optical fiber may comprise a plurality of thin fiber traces or a coated waveguide. Physical stimulus such as bending, breaking, or deforming the optical fiber causes a detectable change in optical properties such as attenuation, reflection, or propagation time.

In another embodiment, the sensor element 14 comprises a planar optical waveguide integrated into or onto the sensor structure 12, configured to exhibit a change in at least one optical property upon physical stimulus. The planar optical waveguide may be fabricated on the substrate 26 of the sensor structure 12 using standard photolithographic or similar fabrication processes.

In another embodiment, the sensor structure 12 comprises a glass substrate 26 with one or more optical waveguides embedded within the glass by ion exchange, laser writing, or photolithographic processes. The optical waveguides form the sensor element 14 and are configured to exhibit a change in at least one optical property upon physical stimulus to the glass substrate 26. The glass substrate 26 provides excellent transparency to inspection (requiring attackers to rely on non-visual probing) while being brittle, such that drilling or cutting generates detectable fractures that disrupt the optical waveguides. Multiple waveguides may be written at different depths within the glass substrate 26, creating a three-dimensional sensor network within a single glass panel.

In embodiments where the sensor element 14 comprises an optical fiber or optical waveguide, the processing circuit 202 is operationally coupled to the optical sensor element via an optical interface. The optical interface comprises at least one light source, such as a laser diode or light-emitting diode, for injecting light into the optical fiber or waveguide, and at least one photodetector for converting received optical signals into electrical signals for processing by the processing circuit 202. The processing circuit 202 may measure at least one of: optical attenuation, indicating damage or bending of the optical path; optical signal propagation time, indicating changes in the optical path length or refractive index; or optical reflection characteristics, indicating discontinuities along the optical path. In a preferred variant, the processing circuit 202 performs optical time domain reflectometry by transmitting an optical pulse into the optical fiber or waveguide and measuring reflections returning from discontinuities along the optical path, enabling the processing circuit 202 to determine both the occurrence and approximate location of physical manipulation. The processing circuit 202 stores a reference optical profile during initialization and detects tampering when subsequent measurements deviate from the reference beyond a configurable threshold.

In another embodiment, the sensor element 14 comprises at least one piezoelectric transducer configured to propagate acoustic waves through the sensor structure 12. The processing circuit 202 monitors at least one acoustic property, such as propagation time, amplitude, frequency response, or reflection pattern, of acoustic waves transmitted through the sensor structure 12. Physical manipulation of the sensor structure 12-including drilling, cutting, delamination, or material substitution-alters the acoustic transmission characteristics, causing a detectable change. The piezoelectric transducers may be disposed at the edges or corners of the sensor structure 12. In a preferred variant, the processing circuit 202 performs ultrasonic pulse-echo or through-transmission measurements at predetermined intervals, and tampering is detected when the received acoustic signature deviates from a stored reference signature beyond a configurable threshold.

In another embodiment, the sensor element 14 comprises at least one strain gauge or piezoresistive element disposed on or within the sensor structure 12. The piezoresistive element exhibits a change in resistance proportional to mechanical strain applied to the sensor structure 12. The processing circuit 202 monitors the resistance of the strain gauge to detect bending, flexing, or mechanical deformation indicative of a tampering attempt. A plurality of strain gauges may be distributed across the sensor structure 12 in a rosette or grid arrangement, enabling detection of strain direction and magnitude. This embodiment is particularly suited for detecting attempts to pry apart or deform the sensor structure 12 without severing conductive traces.

In another embodiment, the sensor element 14 comprises at least one magnetoresistive element or Hall-effect sensor disposed within the sensor structure 12, and at least one permanent magnet or patterned magnetic material disposed at a known position relative to the magnetoresistive element. The processing circuit 202 monitors the magnetic field pattern at the sensor locations. Displacement of a sensor structure 12, removal of a module, or insertion of ferromagnetic tools or probes alters the measured magnetic field, causing a detectable change. In a preferred variant, a unique arrangement of magnetic elements creates a magnetic fingerprint for each module, and the processing circuit 202 verifies the magnetic fingerprint during initialization and periodically during operation.

The processing circuit 202 may be configured to measure at least one of: resistance, capacitance, impedance, inductance, signal propagation time, signal reflection characteristics, or rate of temperature change. In a preferred variant, the processing circuit 202 measures the resistance of the conductive trace. In another variant, the processing circuit 202 measures the capacitance of the conductive trace towards an adjacent component, such as a shielding layer 24 or another conductive trace. In another variant, the processing circuit 202 measures the inductance of the conductive trace. In another variant, the processing circuit 202 measures the time it takes for a signal to propagate through the conductive trace. In another variant, the processing circuit 202 measures the rate of temperature change, where rapid temperature changes exceeding a predetermined threshold indicate potential tampering attempts through thermal attacks.

The measurement may be performed continuously at the clock frequency of the processing circuit 202, or on demand. On-demand measurement is especially relevant when combined with a physical unclonable function derived from the conductive traces, as described herein. The processing circuit 202 may measure the absolute value of a property of one trace, or the difference of the values between two traces.

The measured value may be a property that is unique to the conductive trace, constituting a physical unclonable function. Such physical unclonable functions may be derived from differential capacitance measurements or differential signal propagation time measurements in differential pairs of conductive traces.

In another embodiment, the conductive traces forming the sensor element 14 have a layout that is randomized or pseudo-randomized for each manufactured module 10, such that no two modules have an identical trace layout. The randomization may be generated during the design phase and applied during printed circuit board fabrication. This per-unit variation prevents an attacker from developing a universal bypass strategy applicable to all modules. Combined with a physical unclonable function derived from the trace properties, the randomized layout further strengthens the uniqueness of each module's measurable signature.

Referring to FIG. 3, the processing circuit 202 is operationally coupled to the sensor element 14 via a signal converter 210. The signal converter 210 conditions signals between the sensor element 14 and the processing circuit 202 for performing the measurements described herein. In a preferred embodiment for capacitance measurement, the signal converter 210 comprises an excitation circuit that applies an alternating signal to a first conductive trace and a measurement circuit that detects the resulting signal on a second conductive trace. The measurement circuit may comprise a transimpedance amplifier for converting the current response to a voltage signal suitable for digitization by the processing circuit 202. For differential capacitance measurement, the excitation circuit applies anti-phase signals to two neighboring conductive traces forming a differential pair, and the signal converter 210 measures the differential current response on a third conductive trace. Because the anti-phase excitation cancels the absolute capacitance component, the resulting measurement reflects only the capacitance difference between the two traces, achieving high resolution of small variations. For resistance measurement, the signal converter 210 may apply a known current to the conductive trace and measure the resulting voltage drop. The signal converter 210 may further comprise analog multiplexors to sequentially measure a plurality of conductive traces using a shared measurement channel, thereby reducing circuit complexity while enabling measurement of all sensor elements 14 within the continuous perimeter 122.

In an embodiment, measuring the time it takes for a signal to propagate through the conductive trace enables the detection of certain attack vectors that are otherwise difficult to detect, such as attacks that add new parallel traces upon the existing traces, or attacks that attempt to delaminate sensor structures 12. In a preferred variant, the time difference in two neighboring traces forming a differential pair is measured to increase the measurement resolution and to reduce the impact of environmental noise, such as temperature changes and related thermal expansion. Further, in a preferred variant, the conductive trace passes through a multitude of layers when the sensor structure 12 has multiple stacked layers. This prevents an attacker from delaminating the sensor structure 12 without disrupting the signal propagation path.

In another embodiment, the signal propagation time measurement is performed using a high-precision time-to-digital converter with resolution capabilities of at least 10 picoseconds. The measurement system employs a phase-locked loop operating at frequencies between 100 MHz and 1 GHz to generate precise timing references. The processing circuit 202 measures both rising and falling edge propagation times to detect any asymmetric modifications to the traces.

In another embodiment, the processing circuit 202 measures signal reflection characteristics of the conductive trace using time domain reflectometry. The processing circuit 202 transmits a signal pulse into the conductive trace and measures reflections returning from impedance discontinuities along the trace. Each location where the trace changes in cross-section, material, or geometry produces a characteristic reflection. The processing circuit 202 stores a reference reflection profile during initialization and compares subsequent measurements against the stored reference. Physical manipulation of the sensor structure 12, such as drilling, cutting, bridging, or delamination introduces new impedance discontinuities or alters existing ones, causing a detectable change in the reflection profile. Time domain reflectometry enables the processing circuit 202 to determine not only that tampering has occurred but also the approximate location along the conductive trace where the impedance change was introduced. In a preferred variant, the processing circuit 202 performs time domain reflectometry on a plurality of conductive traces within the sensor structure 12, enabling spatial localization of tampering across the sensor structure 12.

In an embodiment, the sensor element 14 is covered by at least one shielding layer 24. The shielding layer 24 is preferably applied on both sides of the sensor structure 12. The shielding layer 24 is preferably made of copper. Other variants may include stainless steel, mu-metal, tungsten or lead. In a preferred variant, the shielding layer 24 is applied through a coating process such as electroless plating. In another variant, the shielding layer 24 may be applied using shielding tape.

The shielding layer 24 on the inner side of the sensor structure 12, facing the protected volume 124, shields the sensitive device 116 and the processing circuit 202 against electromagnetic side-channel analysis and electromagnetic fault injection. The sensor structure 12 physically protects this inner shielding layer 24, such that an attacker cannot access or remove the inner shielding layer 24 without traversing the sensor element 14.

The shielding layer 24 on the outer side of the sensor structure 12 reduces environmental electromagnetic interference on the sensor element 14, thereby improving measurement stability. Removal of the outer shielding layer 24 exposes the sensor element 14 to environmental electromagnetic influences, causing a detectable change in at least one measurable property of the sensor element 14.

In an embodiment, a shielding perimeter 140 equivalent to a Faraday cage encloses a shielded volume 144 within the protected volume 124. The shielded volume 144 provides electromagnetic shielding for components disposed within it, such as the sensitive device 116 and the processing circuit 202, against electromagnetic side-channel analysis and electromagnetic fault injection. Components that do not require electromagnetic shielding, such as an external battery 156, may be disposed within the protected volume 124 but outside the shielded volume 144.

In a preferred variant, the shielding perimeter 140 is formed by the shielding layers 24 of the tamper-responsive modules forming the continuous perimeter 122 being continuous across the continuous perimeter 122. In this variant, the shielding perimeter 140 coincides with the continuous perimeter 122, and the shielded volume 144 is coextensive with the protected volume 124. Measuring the capacitance between the sensor element 14 and the shielding layer 24 enables the detection of whether the shielding perimeter 140 has been compromised, for example whether the shielding layer 24, or parts of it, have been removed. The shield-to-trace capacitance may be monitored with sufficient resolution to detect attempts at shield removal or modification, for example with a resolution of 0.1 pF.

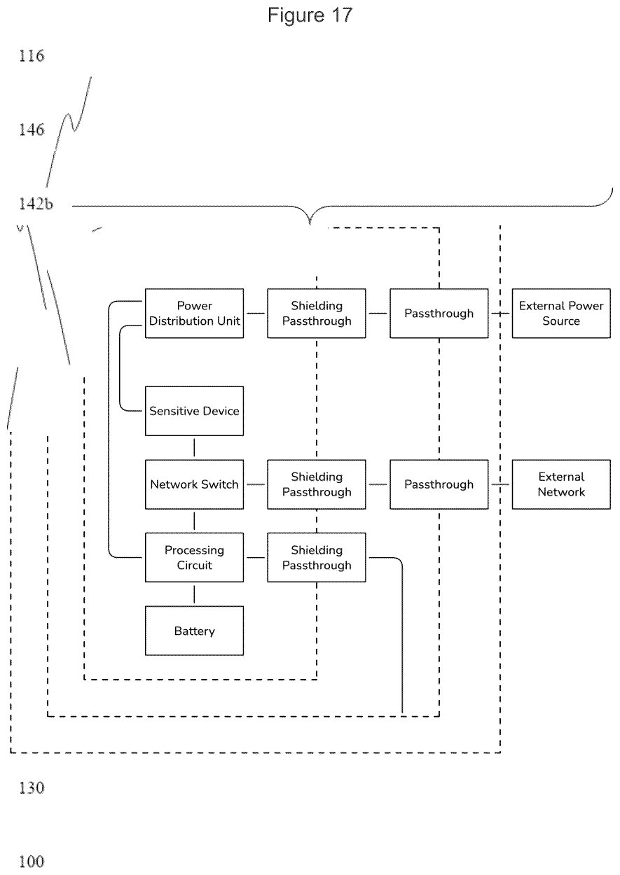

Referring to FIG. 17, in another variant, the shielding perimeter 140 is formed by one or more independent shielding structures disposed within the protected volume 124, separate from the sensor structures 12 forming the continuous perimeter 122. The independent shielding structures enclose the shielded volume 144 as a distinct enclosure within the protected volume 124. In this variant, the shielded volume 144 is a subset of the protected volume 124, and the protected volume 124 includes regions outside the shielded volume 144 where components that do not require electromagnetic shielding may be disposed.

The electromagnetic shielding layer 24 may provide, for example, approximately 60 dB attenuation from 100 kHz to 1 GHz and approximately 40 dB attenuation from 1 GHz to 10 GHz. The shielding layer 24 may have a thickness of, for example, 35 μm to 70 μm for copper-based shields, with a surface resistivity of, for example, 0.5 mΩ/square or less.

Where a functional element 128 traverses the shielding perimeter 140, a shielding passthrough 142 is defined through the shielding perimeter 140. The shielding passthrough 142 enables the functional element 128 to cross the shielding perimeter 140 while maintaining electromagnetic shielding integrity of the shielded volume 144. Where the shielding perimeter 140 is formed by the shielding layers 24 on the sensor structures 12, the shielding passthrough 142 may comprise a conductive sleeve or tube connecting the shielding layers 24 on opposite sides of the sensor structure 12 around the passthrough 30, such that the functional element 128 passes through both the passthrough 30 and the shielding passthrough 142. Where the shielding perimeter 140 is formed by an independent shielding structure, the shielding passthrough 142 is defined through the independent shielding structure. In another embodiment, the shielding passthrough 142 comprises a waveguide section with dimensions below the cutoff frequency of the frequencies to be shielded, attenuating electromagnetic energy that would otherwise propagate through the passthrough 30. In another embodiment, the shielding passthrough 142 comprises electromagnetic interference filters disposed at the boundary of the shielding perimeter 140, filtering signals entering or exiting the shielded volume 144. The sensor connection 130 between the processing circuit 202 and the sensor structure 12 traverses the shielding perimeter 140 through a shielding passthrough 142.

In another embodiment, electrical signal conductors with a controlled impedance, such as 85 Ohms, are routed through the passthrough 30 to transmit high-speed signals through the sensor structure 12. Such controlled-impedance traces may be disposed at one or multiple layers of a printed circuit board that also includes the sensor layers and the shielding layers 24. Where a multitude of signal traces are in close proximity, for example in a connector with a ball grid array that limits space for lateral movement, the traces may execute multiple lateral movements across multiple layers, or the lateral movements of individual signal traces may be distributed across different layers, enabling a longer lateral displacement for each signal trace.

In another embodiment, the passthrough 30 is configured as an electromagnetic waveguide channel, enabling radio-frequency signals to be routed through the sensor structure 12 without physical conductors. The waveguide channel follows the non-linear path 18 through the sensor structure 12, with the channel dimensions and geometry configured to propagate signals within a specified frequency range. The shielding layer 24 and sensor structure 12 form the waveguide walls. This embodiment enables routing of high-frequency signals (such as millimeter-wave radar or 5G communication signals) through the tamper-detected boundary without the signal integrity challenges associated with routing high-frequency conductors through a non-linear path.

Referring to FIG. 5, in an embodiment the module 10 is configured as a tamper-responsive module with air passthrough interface 106. An outer sensor structure 12a and a connecting sensor structure 12b form an enclosure. Optionally, an inner sensor structure 12c is present on the inner side; however, the inner sensor structure 12c may be omitted. Whether or not the inner sensor structure 12c is present, the passthrough follows a non-linear path 18 from an outer opening 16a to an inner opening 16b. Within the enclosure, a plurality of angled sensor structures are disposed such that the spaces between adjacent angled sensor structures form fluid channels 138 following the non-linear path 18. The angled sensor structures may be arranged in two or more columns, where each column forces the path through additional angles, further increasing the number of direction changes through the passthrough. The number of angled sensor structures and columns determines the number of direction changes in the non-linear path 18. In a preferred variant, at least three angled sensor structures are disposed within the enclosure, such that the non-linear path 18 comprises at least two changes in direction. Additional angled sensor structures or additional columns of angled sensor structures may be disposed within the enclosure to increase the number of required direction changes, further increasing the difficulty of intrusion.

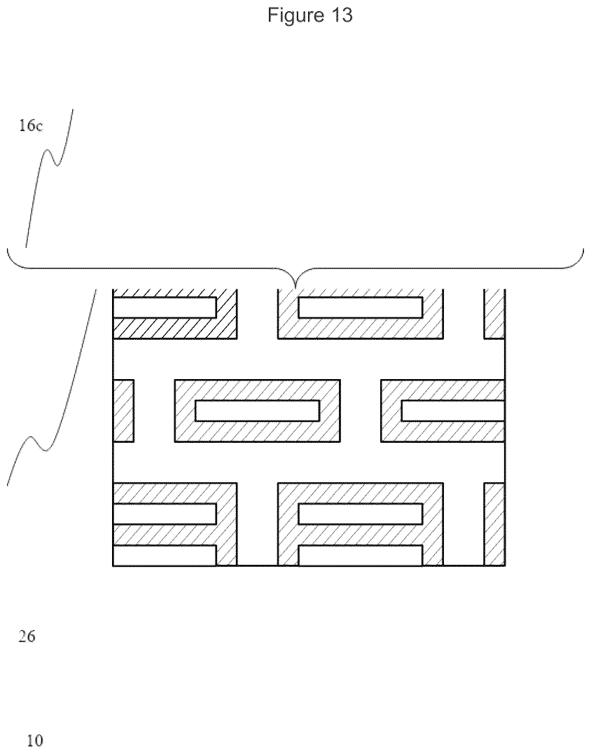

Referring to FIG. 13, in an embodiment the module 10 accommodates thermally conductive material for conductive cooling. The sensor structure 12 may comprise a plurality of sensor layers with elements of high thermal conductivity, such as copper sheets, disposed between the sensor layers. These thermally conductive elements are continuous across the sensor structure 12, enabling a low thermal resistance path for heat conduction from the sensitive device 116 to an external heat sink. In an alternative embodiment, the elements of high thermal conductivity are coupled using a thermal interface material, such as thermal paste or a thermal pad, to minimize thermal contact resistance between the layers. Furthermore, a heat sink may be mechanically attached to the module, potentially extending through the sensor structure via a thermally conductive path that maintains tamper detection integrity. The shielding layers 24 in this embodiment may be implemented as flexible printed circuit boards, which are thin (typical thickness of 50 μm to 100 μm), to further reduce thermal resistance. A straight cut through such a structure will necessarily cut through at least one sensor layer, triggering tamper detection.

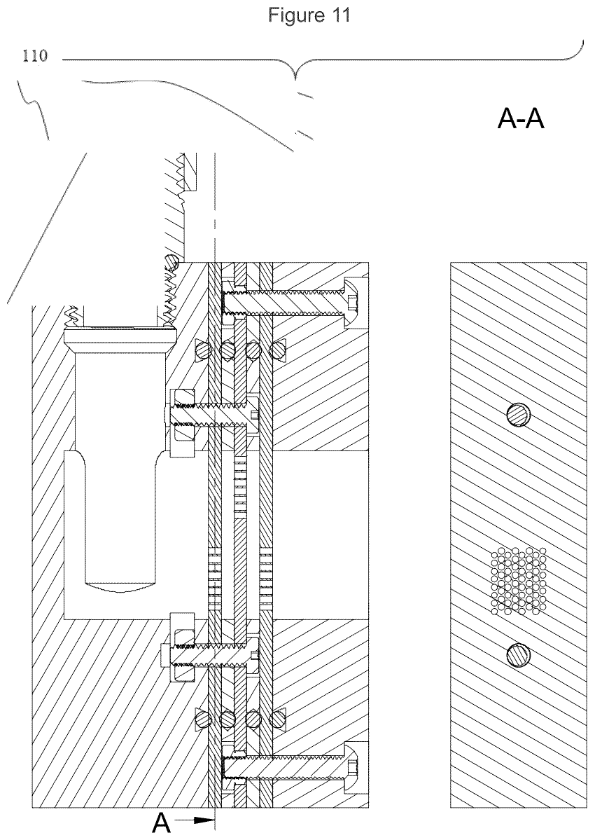

Referring to FIG. 11, in another embodiment the passthrough accommodates a fluid channel 138. The fluid channel 138 may be created between rigid printed circuit boards forming the sensor structure 12, or a support structure may be used to create the fluid channels 138. In a preferred embodiment, a tamper-responsive module with fluid passthrough interface 110 comprises an outer sensor structure 12a, a middle sensor structure 12b, and an inner sensor structure 12c. Each sensor structure has a plurality of openings 16 forming the passthrough.

The non-linear path 18 through the module comprises a first portion 18a formed by the spatial distance between the outer sensor structure 12a and the middle sensor structure 12b, a second portion 18b formed by the openings within the middle sensor structure 12b, and a third portion 18c formed by the spatial distance between the middle sensor structure 12b and the inner sensor structure 12c. In a preferred embodiment, each sensor structure has an array of openings, for example an eight-by-eight array, each opening having a small cross-section such as approximately one millimeter, providing a large total open area for fluid flow while ensuring that sensor elements 14 disposed between adjacent openings detect intrusion through any individual opening.

Mounting brackets 134a, 134b, and 134c are disposed at multiple positions to structurally support the sensor structures, and fastening elements 132 secure the assembly. The fastening elements on the inner side and outer side of the module are not aligned, such that the structural passthrough formed by the fastening elements also follows a non-linear path.

Fluid channels 138 are formed between the sensor structures, and seals 136 are provided to prevent fluid leakage. An optional channel guidance element may ensure a specific pathway of the fluid within the channel. One surface within the channel may have a low thermal resistance towards the heat source, enabling efficient cooling. This surface may be made of a material with high thermal conductivity, such as copper. Alternatively, the cooling fluid may be in direct contact with the heat source, such as a graphics processing unit. The channel may be sealed on the outside with a rubber seal to prevent leakage. The fluid may be water or any fluid commonly used for cooling electronic components.

In another embodiment, the passthrough 30 is sealed and configured to maintain a controlled atmosphere within the protected volume 124. The passthrough 30 may include sealing elements at its openings, and functional elements 128 routed through the passthrough 30 are sealed where they enter and exit the passthrough 30. The controlled atmosphere may be an inert gas (such as nitrogen or argon), a dry atmosphere, or a partial vacuum. The processing circuit 202 may monitor pressure within the protected volume 124 using a pressure sensor, and a change in pressure may indicate a breach of the continuous perimeter 122. This embodiment is suited for protecting components sensitive to humidity, oxidation, or atmospheric contaminants, or for applications where a pressure change provides an additional tamper-detection mechanism.

In another embodiment, the processing circuit 202 monitors temperature within the protected volume 124 using one or more temperature sensors. The processing circuit 202 monitors both absolute temperature and the rate of temperature change, and establishes normal operating temperature ranges and expected rates of change based on the thermal characteristics of the sensitive device 116. Rapid temperature changes exceeding predetermined thresholds, for example changes greater than 10 °C per second, trigger tamper detection, as such rapid changes may indicate thermal attacks attempting to compromise the system. Multiple temperature sensors may be distributed throughout the protected volume 124 to detect localized thermal attacks. The processing circuit 202 may further monitor additional environmental sensors within the protected volume 124, such as a light sensor, a pressure sensor, or a gas sensor, to detect breach of the continuous perimeter 122.

In another embodiment, the processing circuit 202 implements a multi-layered tamper detection algorithm. During an initialization phase, the processing circuit 202 establishes reference values for each measurable property of the sensor structure 12. In a preferred variant, the processing circuit 202 first performs an integrity check by verifying that the electrical properties of all conductive traces are within expected ranges, detecting short circuits and open circuits. Subsequently, the processing circuit 202 continuously monitors the measurable properties and compares them against the established reference values. A first detection mechanism compares the current value of each measurable property against its reference value with a configurable tolerance parameter, triggering a tamper event when the deviation exceeds the tolerance. A second detection mechanism monitors the rate of change of each measurable property between successive measurements, triggering a tamper event when the rate of change exceeds a configurable rate threshold. The tolerance and rate threshold parameters may be tuned to the specific application and environmental conditions. The multi-layered approach enables detection of both gradual tampering attempts, which are detected by the first mechanism over time, and rapid tampering attempts, which are detected by the second mechanism between successive measurements.

In a preferred embodiment, cryptographic keys and attestation credentials are stored in volatile memory, such as battery-backed static random-access memory (SRAM), within the protected volume 124. The volatile memory is powered by the internal battery 208 or other power source managed by the power management unit 206. Because the volatile memory retains data only while power is supplied, disconnecting power from the volatile memory causes immediate and irreversible loss of the stored keys. This enables passive zeroization: upon detection of a tamper event, the processing circuit 202 disconnects power to the volatile memory, and the cryptographic keys are destroyed without requiring an active overwrite operation. Passive zeroization is faster and more reliable than active erasure of non-volatile memory, as it does not depend on the execution of software instructions that an attacker might attempt to interrupt. Reference values, encrypted data, firmware, and other non-sensitive configuration data may be stored separately in non-volatile memory 204, which retains its contents regardless of power state.

The system may cause a reaction upon detection of tampering. In a preferred variant, the processing circuit 202 disconnects power to the volatile memory storing the cryptographic keys, causing immediate zeroization such that the device can no longer attest to an untampered state. In another variant, the system erases sensitive data stored within the protected volume 124. In another variant, the system includes a component for destroying the sensitive device 116 or at least parts of it. This could be a sheet including nano-thermite for thermal destruction, an electrical charge for causing gate oxide breakdown, or a chemical compound such as acid for chemical destruction. In another variant, the system generates a tamper alert notification.

In another embodiment, the processing circuit 202 is configured to communicate tamper status to a remote verification system via a network interface. The processing circuit 202 periodically transmits a signed attestation message confirming the integrity of the sensor structure 12. Failure to receive the attestation message within a predetermined interval, or receipt of a message indicating a tamper event, enables the remote verification system to take protective action, such as revoking trust in the sensitive device 116, disabling remote access, or dispatching physical security personnel. The attestation protocol may use a challenge-response mechanism to prevent replay attacks. This embodiment is particularly suited for deployments where the tamper-detection system 100 is in an unattended or remote location.

Referring to FIG. 3, in a preferred embodiment, the processing circuit 202 is powered via a power management unit 206 that manages multiple power sources to ensure continuous monitoring of the sensor structure 12. The system comprises at least an internal battery 208 disposed within the protected volume 124 and at least one external battery 156 disposed outside the protected volume 124. The internal battery 208 provides sufficient energy to sustain the processing circuit 202 for at least the duration required to complete zeroization of all cryptographic keys and sensitive data upon detection of a tamper event or upon loss of all other power sources. The internal battery 208 serves as a last-resort power source ensuring that tamper response can always be executed. The at least one external battery 156 has a higher capacity than the internal battery 208 and enables extended operation of the system without an external power source. In a preferred variant, the system comprises at least two external batteries 156 connected in parallel via the power management unit 206, such that any single external battery 156 may be removed or replaced without interrupting power to the processing circuit 202 and without triggering a tamper event. This enables field maintenance of the external batteries 156 while maintaining continuous tamper detection.

The power management unit 206 preferentially draws power from an external power source 146 when available, then from the external batteries 156, and finally from the internal battery 208. The power management unit 206 monitors the state of charge of each battery 156, 208 independently. If the charge of the internal battery 208 falls below a predetermined threshold, the power management unit 206 triggers zeroization while sufficient energy remains to complete the process. The power management unit 206 may further generate alerts when external battery 156 capacity is low, prompting maintenance before the system must rely on the internal battery 208. Upon detection of a power loss event on any power source, the processing circuit 202 may initiate a tamper detection sequence to verify the integrity of the sensor structure 12 before resuming normal operation.

In another embodiment, the internal battery 208 is replaced by or supplemented with a supercapacitor disposed within the protected volume 124. The supercapacitor provides sufficient energy to complete zeroization upon loss of all other power sources. The supercapacitor offers long cycle life and a wide operating temperature range, making it suited for applications where long shelf life without maintenance is required. The power management unit 206 maintains the supercapacitor at full charge during normal operation.

In an alternative embodiment, the system operates without a battery by deriving a cryptographic key from a physical unclonable function (PUF) of the sensor structure 12. During an enrollment phase performed during initial commissioning, the processing circuit 202 measures the PUF values derived from the sensor structure 12 (such as differential capacitance values or differential signal propagation times), derives a cryptographic key from the measured PUF values, encrypts the sensitive data and attestation credentials using the derived key, and stores the encrypted data in non-volatile memory 204. The derived key is then deleted from volatile memory. Upon each subsequent power-up, the processing circuit 202 re-measures the PUF values from the sensor structure 12, re-derives the cryptographic key, and attempts to decrypt the stored data. If the sensor structure 12 has been tampered with while the system was powered off, the PUF values will have changed, the re-derived key will differ from the original, and the decryption will fail, thereby preventing access to the sensitive data and indicating that tampering has occurred. This approach eliminates the need for an external battery 156 or internal battery 208 while providing inherent detection of offline tampering attempts. Error correction codes may be applied during key derivation to compensate for minor environmental variations such as temperature drift, while ensuring that physical modifications to the sensor structure 12 caused by tampering exceed the error correction capability.

In another embodiment, the tamper-detection system 100 comprises a plurality of local processing elements, each associated with one or more tamper-responsive modules, and a central processing circuit 202 that communicates with the local processing elements. Each local processing element performs sensor measurements for its associated module or modules and reports status to the central processing circuit 202. This distributed architecture reduces the length of sensor connections 130, improves measurement signal integrity, and enables faster local detection and response. The communication between local processing elements and the central processing circuit 202 may be authenticated and encrypted to prevent spoofing of tamper status reports. Each local processing element may independently trigger a local tamper response, such as activating a local zeroization circuit, without requiring authorization from the central processing circuit 202.

In another embodiment, the tamper-detection system 100 is configured to conform to a standard equipment rack form factor, such as a 19-inch rack or an Open Compute Project rack specification. The support frame 120 is configured to mount to the rack, for example by attaching to the rack rails or replacing a standard rack unit chassis. The tamper-responsive modules form the continuous perimeter 122 within the support frame 120, enclosing a protected volume 124 that occupies one or more rack units. The passthroughs 30 accommodate standard rack power distribution and network cabling routed from outside the continuous perimeter 122 to the sensitive devices 116 within the protected volume 124. This embodiment enables deployment within existing data center infrastructure with minimal modification to the facility.

In another embodiment, the tamper-detection system 100 is configured for mobile or field deployment, comprising a ruggedized support frame 120 with shock and vibration isolation. The tamper-responsive modules are secured against displacement due to transport vibrations through latching mechanisms at the terminal interfaces 20. The processing circuit 202 is configured to distinguish between vibration signatures associated with normal transport and those associated with tampering, using adaptive thresholds that account for the expected vibration environment. The system may include GPS or inertial navigation sensors, and movement outside a geofenced area may trigger a tamper event.

In another embodiment, the tamper-detection system 100 is configured as a shipping container for chain-of-custody applications. The continuous perimeter 122 encloses the contents of the container, and the processing circuit 202 logs tamper events during transit. The system may include a real-time clock and a communication module (such as cellular or satellite) to transmit tamper status and location during transit. Upon delivery, the recipient can verify the integrity of the shipment by reading the tamper event log and confirming the attestation status. This embodiment is suited for transporting sensitive materials such as pharmaceuticals, biological samples, forensic evidence, or classified documents.

In another embodiment, the tamper-detection system 100 is configured as a retrofit kit for existing equipment enclosures such as server cabinets, safes, or industrial control enclosures. The tamper-responsive modules are dimensioned to attach to the interior or exterior surfaces of the existing enclosure. The terminal interfaces 20 and support mounting features accommodate attachment to surfaces of varying geometry and material. The retrofit kit enables upgrading existing enclosures with tamper-detection capability without replacing the enclosure itself.

In operation, the system provides tamper-detected access through the tamper-responsive passthrough module 10 by: providing a sensor structure 12 having at least one measurable property; defining a passthrough 30 through the sensor structure 12, wherein the passthrough 30 follows a non-linear path 18 bounded by the sensor structure 12; routing at least one functional element 128 through the passthrough 30 along the non-linear path 18; and monitoring the measurable property to detect physical manipulation of the sensor structure 12.

FIG. 1 is a schematic diagram showing a three-dimensional exploded view of a tamper-detection system 100 according to an illustrative embodiment. The system 100 comprises a support frame 120 configured to receive and retain a plurality of tamper-responsive modules. Tamper-responsive modules with structural passthrough interfaces 108a and 108b are mounted to the support frame 120. On two opposite sides of the support frame 120, tamper-responsive modules with air passthrough interfaces 106a and 106b are shown in exploded position. On three sides of the support frame 120, tamper-responsive modules without passthroughs 114a, 114b, and 114c are shown in exploded position. On the top of the support frame 120, a tamper-responsive module with filament passthrough interface 104 is shown in exploded position. Within the support frame 120, a sensitive device 116 and a processing circuit 202 are shown in their operational positions within the protected volume.

FIG. 2 is a schematic diagram showing a three-dimensional exploded view and a non-exploded detail view of a tamper-responsive module with filament passthrough interface 104 according to an illustrative embodiment. The exploded view shows the module comprising three stacked sensor structures 12a, 12b, and 12c, each containing a sensor element 14a, 14b, and 14c respectively. The sensor structure 12a has a first opening 16a, the middle sensor structure 12b has two openings 16b and 16c (one aligned with the first opening and one offset toward the opposite side), and the sensor structure 12c has an opening 16d aligned with the offset opening of the middle layer. A non-linear path 18 connects the aligned openings through the lateral displacement region between the middle sensor structure's two openings 16b and 16c. Each sensor element has a terminal interface 20 on each side for coupling to other modules or to the processing circuit; terminal interfaces 20a, 20b, 20c, 20d, 20e, 20f, and 20g are shown.

The non-exploded detail view of FIG. 2 shows a close-up of the assembled module edge. Each sensor structure comprises an additional sensor element 14d, 14e, and 14f respectively, disposed at the edge of each sensor structure. Sensor coupling elements 22a and 22b comprise castellated holes with solder joints connecting the sensor elements between adjacent sensor structures at the module edge. The castellated holes are formed at the edges of each sensor structure, and solder is applied through the castellated holes to connect to terminal interfaces 20i and 20j of the sensor elements on adjacent layers, establishing permanent connections between the sensor elements across the stacked sensor structures. The coupled sensor chain terminates in terminal interfaces 20h and 20g at its respective ends, configured to couple to another tamper-responsive module or to a processing circuit. Because the sensor coupling elements 22a and 22b are positioned at the interior edges of the assembled module, disassembly of the stacked sensor structures necessarily breaks the solder joints at the castellated holes, causing a detectable change in at least one measurable property.

FIG. 3 is a block diagram of a tamper-detection system 100 according to an illustrative embodiment. A continuous perimeter 122 encloses a protected volume 124. An external interface 126 is shown outside the continuous perimeter 122. A passthrough 30 is shown at the boundary of the continuous perimeter 122, connecting the external interface 126 to components within the protected volume 124. A sensor connection 130 couples the continuous perimeter 122 to a signal converter 210. The signal converter 210 is operationally coupled to a processing circuit 202 and conditions signals between the continuous perimeter 122 and the processing circuit 202 for performing measurements. A power management unit 206 is operationally coupled to the processing circuit 202 and manages power from an external power source, at least one external battery 156, and an internal battery 208. A non-volatile memory 204 is coupled to the processing circuit 202 for storing reference values, encrypted data, and configuration data. Cryptographic keys and attestation credentials are stored in volatile memory powered by the internal battery 208.

FIG. 4 is a block diagram showing a tamper-detection system 100 according to an illustrative embodiment. A tamper-responsive passthrough module 10 and a tamper-responsive module without passthrough 114 are coupled to each other, enclosing a protected volume 124 containing a sensitive device 116 and a processing circuit 202. The processing circuit 202 is operationally coupled to the modules via a sensor connection 130. An external interface 126 is shown outside the protected volume 124. A functional element 128 connects from the external interface 126 through the tamper-responsive passthrough module 10, branching to both the sensitive device 116 and the processing circuit 202. A first opening 16a is shown at the outer boundary of the tamper-responsive passthrough module 10 and a second opening 16b at the inner boundary, connected by a non-linear path 18 meandering between the two openings 16a and 16b, forming the passthrough 30. An intrusion attempt is shown being blocked by the non-linear path 18 within the tamper-responsive passthrough module 10. The intrusion attempt cannot reach the protected volume 124 because it contacts the sensor structure 12a within the non-linear path 18, causing a detectable change. The tamper-responsive module without passthrough 114 comprises a sensor structure 12b.

FIG. 5 is a section view of a tamper-responsive module with air passthrough interface 106 according to an illustrative embodiment. Multiple sensor structures 12 are shown. An outer sensor structure 12a has a large first opening 16a. An inner sensor structure 12c has a large second opening 16b. A connecting sensor structure 12b bridges the outer sensor structure 12a and the inner sensor structure 12c, forming a spatial enclosure between them. Within the enclosure, a plurality of angled sensor structures 12d, 12e, 12f, and 12g are disposed. The angled sensor structures are not touching each other, and the spaces between the angled sensor structures form fluid channels 138. In order to traverse from the outer opening 16a to the inner opening 16b, an object must follow a non-linear path 18 through the fluid channels 138 between the angled sensor structures.

FIG. 6 is a section view of a tamper-responsive module with structural passthrough interface 108 according to an illustrative embodiment. An outer sensor structure 12a is disposed on the outside and an inner sensor structure 12b is disposed on the inside. A mounting bracket 134 is positioned between the outer sensor structure 12a and the inner sensor structure 12b. The support frame 120 is positioned adjacent to the inner sensor structure 12b. Fastening elements 132a, 132b, 132c, and 132d secure the assembly. On the outside, clinched threaded studs 132a are connected to the mounting bracket 134 and protrude through the outer sensor structure 12a, where they are secured by nuts 132b. On the inside, countersunk screws 132c are embedded in the inner sensor structure 12b and protrude through the support frame 120, where they are secured by nuts 132d. Sensor coupling elements 22, implemented as spring-loaded contact pins (pogo pins), are soldered to the inner sensor structure 12b and make contact with the terminal interface 20 on the outer sensor structure 12a. A sensor connection 130 is shown connected to the inner sensor structure 12b.

FIG. 7 is a three-dimensional schematic diagram showing the interior of a cube formed by a plurality of sensor structures 12 according to an illustrative embodiment. The view is from inside the cube, with three sides visible and the other three sides hidden from view. Three outer sensor structures 12a, 12b, and 12f form the outer planar surfaces of the arrangement. Three inner sensor structures 12c, 12d, and 12e are disposed within, interlocked with the outer sensor structures and with each other. The outer sensor structures form planar surfaces that are straightforward to manufacture, such as printed circuit boards or other planar substrates. The inner sensor structures 12c, 12d, and 12e may be made from the same materials as the outer sensor structures, such as printed circuit boards or other planar substrates. The inner sensor structures are arranged perpendicular to the outer sensor structures and interlock with them at edges, and the inner sensor structures further interlock with each other, such that any straight-line path from outside to inside the arrangement intersects at least one sensor structure 12. The interlocking arrangement ensures that openings at edges and corners on the outside and inside are connected only by non-linear paths through the sensor structures, preventing direct access through gaps that may arise from manufacturing tolerances at edges and corners.

FIG. 8 is a two-dimensional cross-section through the interlocked sensor structure arrangement of FIG. 7 according to an illustrative embodiment. Outer sensor structures 12a, 12b, and 12f and inner sensor structures 12c, 12e, and 12d are shown. A recess is formed in the outer sensor structure 12a; if the sensor structure 12a is a printed circuit board, this recess may be a half-depth milled slot. The inner sensor structure 12c is embedded in this recess, protruding perpendicular to the outer sensor structure 12a. The inner sensor structure 12c closes the gap between the outer sensor structures 12a and 12b, such that an attacker attempting to access the interior through the joint between 12a and 12b must follow a non-linear path around the inner sensor structure 12c. This interlocking arrangement prevents direct linear access through edge joints and corners of the sensor structure arrangement.

FIG. 9 is a schematic diagram of a trace layout forming the sensor element 14 according to an illustrative embodiment. Four sensor elements are shown in a meandering arrangement, all disposed in the same plane. On the left side of the diagram, a first sensor element 14a and a second sensor element 14b are arranged in an interleaving pattern. On the right side of the diagram, a third sensor element 14c and a fourth sensor element 14d are arranged in a similar interleaving pattern. The interleaving arrangement of paired sensor elements enables capacitive coupling between the sensor elements and differential measurements. Each sensor element terminates in terminal interfaces 20; for example, sensor element 14a terminates in terminal interfaces 20b and 20d, and sensor element 14b terminates in terminal interfaces 20a and 20c.

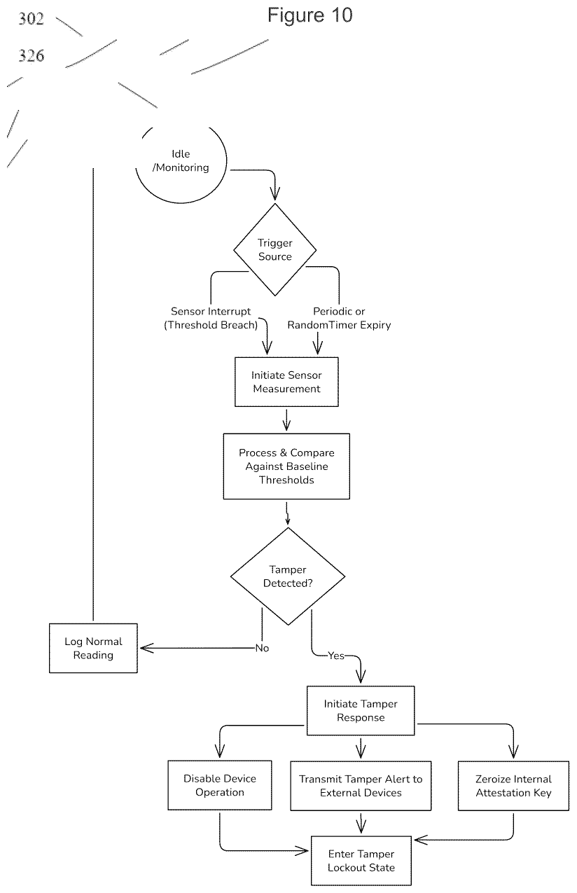

FIG. 10 is a flow diagram of a tamper detection process according to an illustrative embodiment. The process initiates with a System Initialization & Sensor Calibration step 302. During this step, the system establishes baseline parameters for the sensors. The system then transitions to an Idle/Monitoring state 304, where it awaits a trigger event. A trigger source determines the subsequent action. Triggers may include a sensor interrupt, such as a threshold breach 306a, or a periodic or random timer expiry 306b. Upon receiving a trigger, the system proceeds to Initiate Sensor Measurement 310, capturing data from the sensor structure. This data is then analyzed in the Process & Compare Against Baseline Thresholds step 312. A decision block, Tamper Detected? 314, evaluates whether the processed data indicates a tamper event. If no tamper is detected, the system proceeds to Log Normal Reading 316 and returns to the Idle/Monitoring state 304. If a tamper is detected, the system executes an Initiate Tamper Response step 318. The response comprises one or more protective actions, which may be performed substantially simultaneously or in a specific sequence: Disable Device Operation 320 to prevent further unauthorized use; Transmit Tamper Alert to External Devices 322 to notify monitoring systems; and Zeroize Internal Attestation Key 324 to erase sensitive cryptographic material. Following the response actions, the system enters a Tamper Lockout State 326, requiring authorized intervention to reset.

FIG. 11 is a schematic diagram of a tamper-responsive module with fluid passthrough interface 110 according to an illustrative embodiment. An outer sensor structure 12a, a middle sensor structure 12b, and an inner sensor structure 12c are shown. Each sensor structure has a plurality of openings 16; the outer sensor structure 12a has openings 16 including 16c and 16d, and the inner sensor structure 12c has openings including 16a and 16b. In a preferred embodiment, each sensor structure has an array of openings, for example an eight-by-eight array, each opening having a small cross-section such as approximately one millimeter, providing a large total open area for fluid flow while ensuring that sensor elements are disposed between adjacent openings to detect intrusion through any individual opening. A non-linear path 18 is formed through the module, comprising a first portion 18a formed by the spatial distance between the outer sensor structure 12a and the middle sensor structure 12b, a second portion 18b formed by the openings within the middle sensor structure 12b, and a third portion 18c formed by the spatial distance between the middle sensor structure 12b and the inner sensor structure 12c. A support frame 120 is disposed on the inside of the module. Mounting brackets are provided at multiple positions: an outer mounting bracket 134a on the outside, a middle mounting bracket 134b between the outer sensor structure 12a and the middle sensor structure 12b, and an inner mounting bracket 134c between the middle sensor structure 12b and the inner sensor structure 12c. Fastening elements 132 secure the assembly: fastening elements 132c and 132d clamp together the middle sensor structure 12b, the inner mounting bracket 134c, the inner sensor structure 12c, and the support frame 120; fastening elements 132a and 132b clamp together the outer sensor structure 12a, the outer mounting bracket 134a, the middle mounting bracket 134b, and the middle sensor structure 12b. The fastening elements on the inner side and the outer side are not aligned with each other, such that the structural passthrough formed by the fastening elements also follows a non-linear path. The spaces between the sensor structures form fluid channels 138. The outer mounting bracket 134a includes an external interface 126 comprising a coupling for liquid tubing. A plurality of seals 136 are provided to prevent fluid leakage from the module.

FIG. 12 is a schematic diagram of the cross-section of a tamper-responsive passthrough module 10 according to an illustrative embodiment. A substrate 26 spans the body of the module. Three layers of sensor elements 14 are disposed within the substrate 26: sensor elements 14a and 14d on a first outer layer, sensor elements 14b and 14e on a middle layer, and sensor elements 14c and 14f on a second outer layer. Shielding layers 24a and 24c are disposed on one outer surface of the module, and shielding layers 24b and 24d are disposed on the opposite outer surface. Openings 16a and 16b are formed on opposite sides of the module, connected by a non-linear path 18a. Openings 16c and 16d are similarly formed on opposite sides, connected by a non-linear path 18b. Each non-linear path 18 passes through the first sensor layer, makes a lateral displacement, passes through the second sensor layer, makes another lateral displacement, and passes through the third sensor layer.

FIG. 13 is a schematic diagram of the cross-section of a tamper-responsive passthrough module 10 according to an illustrative embodiment, comprising a plurality of sensor layers with elements of high thermal conductivity disposed between the sensor layers for low thermal resistance. A substrate 26 spans the body of the module. Sensor elements are disposed within the substrate 26 across three layers: sensor elements 14a and 14d on a first layer, sensor elements 14b and 14e on a second layer, and sensor elements 14c and 14f on a third layer. Shielding layers 24a and 24c are disposed on one outer surface, and shielding layers 24b and 24d are disposed on the opposite outer surface. Openings 16a, 16b, 16c, and 16d are formed through the structure, connected by a single continuous non-linear path 18. A straight cut through the structure necessarily intersects at least one sensor layer, causing tamper detection. The elements of high thermal conductivity are continuous between the sensor layers, enabling a low thermal resistance path through the sensor structure. In a preferred embodiment, the sensor elements are disposed on thin sensor structures such as flexible printed circuit boards, providing a short bridging distance and enabling a large passthrough area for thermal conduction.

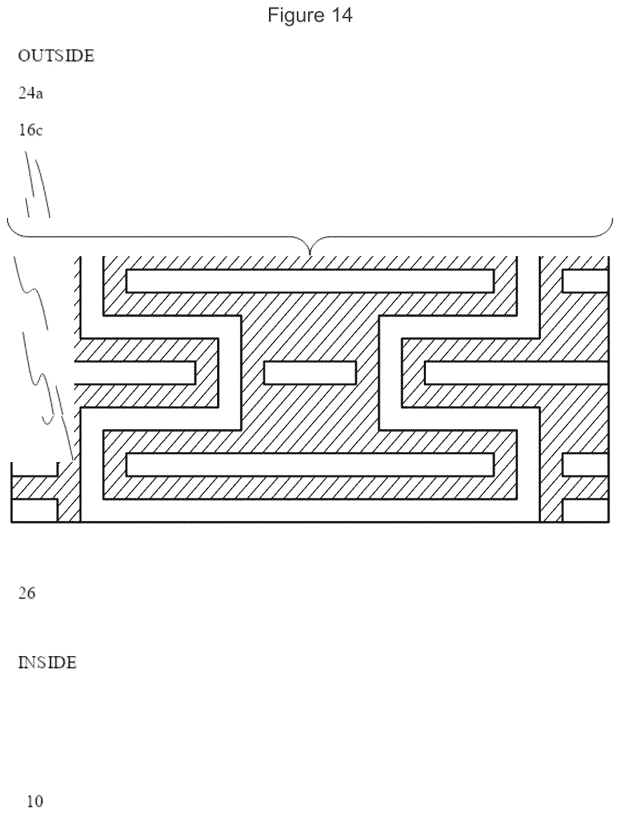

FIG. 14 is a schematic diagram of a tamper-responsive passthrough module 10 according to an illustrative embodiment, with a fluid channel routed through the sensor structure via non-linear paths. A substrate 26 spans the body of the module. Sensor elements are disposed within the substrate 26 across three layers: sensor elements 14a and 14d on an outer layer, sensor elements 14b and 14e on a middle layer, and sensor elements 14c and 14f on an inner layer. Shielding layers 24a and 24c are disposed on the outer surface, and a shielding layer 24b is disposed on the inner surface. On the outside, two openings 16a and 16c provide connections for entry and exit of the cooling fluid. On the inside, a single opening 16b connects the two non-linear paths, providing a surface for heat absorption. Non-linear path 18a connects opening 16a to opening 16b, and non-linear path 18b connects opening 16c to opening 16b. This arrangement is particularly suited for fluid passthrough, where the inside surface may be attached to a cold plate or heat exchanger for efficient cooling.

FIG. 15 is a schematic diagram of an unfolded flexible printed circuit board forming a sensor structure 12 with bending lines 28a, 28b, and 28c according to an illustrative embodiment. The sensor structure 12 is intended to be first folded along bending line 28c by 90 degrees to form the shape of a U. Afterwards, it is intended to be folded along bending line 28a by 90 degrees, and simultaneously folded along bending line 28b, to achieve the folded form depicted in FIG. 16.

FIG. 16 is a schematic diagram of a folded flexible printed circuit board used to cover edges and corners according to an illustrative embodiment. It shows a top surface 12a, a bottom surface 12b, and a side surface 12c. There is no gap between the side surface 12c and the top surface 12a, and there is no gap between the side surface 12c and the bottom surface 12b. There is no gap at the intersection between two side surfaces and the bottom surface 12b or the intersection between two side surfaces and the top surface 12a. This shape enables continuous tamper detection coverage at edges and corners.

FIG. 17 is a block diagram of a tamper-detection system 100 with a shielding perimeter 140 and shielding passthroughs 142 according to an illustrative embodiment. A continuous perimeter 122 encloses a protected volume 124. An opaque encapsulant 150 is disposed on the continuous perimeter 122. Within the protected volume 124, a shielding perimeter 140 encloses a shielded volume 144. The shielding perimeter 140 is an independent shielding structure separate from the sensor structures 12 forming the continuous perimeter 122. The shielding perimeter 140 is interrupted by shielding passthroughs 142a, 142b, and 142c. Within the shielded volume 144, a power distribution unit 154 distributes power to a sensitive device 116, a network switch 152, and a processing circuit 202. The network switch 152 distributes data connections to the sensitive device 116 and the processing circuit 202. An internal battery 208 is disposed within the shielded volume 144 and is coupled to the processing circuit 202. An external power source 146 is disposed outside the continuous perimeter 122. A power path connects from the external power source 146, through a passthrough 30a at the boundary of the continuous perimeter 122, through a shielding passthrough 142a at the boundary of the shielding perimeter 140, to the power distribution unit 154 within the shielded volume 144. An external network 148 is disposed outside the continuous perimeter 122. A data path connects from the external network 148, through a passthrough 30a at the boundary of the continuous perimeter 122, through a shielding passthrough 142b at the boundary of the shielding perimeter 140, to the network switch 152 within the shielded volume 144. A sensor connection 130 connects the processing circuit 202, through a shielding passthrough 142c at the boundary of the shielding perimeter 140, to the continuous perimeter 122 for monitoring the sensor structures forming the continuous perimeter 122.

FIG. 18 is a block diagram of a tamper-detection system 100 with nested protected volumes according to an illustrative embodiment. A first continuous perimeter 122a encloses a first protected volume 124a. A second continuous perimeter 122b encloses a second protected volume 124b nested within the first protected volume 124a. A sensitive device 116 is disposed within the first protected volume 124a and outside the second continuous perimeter 122b. A processing circuit 202 is disposed within the second protected volume 124b. A passthrough 30a is defined through the first continuous perimeter 122a, connecting the first protected volume 124a to an external interface 126 disposed outside the first continuous perimeter 122a. A passthrough 30b is defined through the second continuous perimeter 122b. The sensitive device 116 is connected to the external interface 126 through passthrough 30a. The processing circuit 202 is connected through passthrough 30b to passthrough 30a and then to the external interface 126. A sensor connection 130a couples the processing circuit 202 to the first continuous perimeter 122a for monitoring the sensor structures of the first continuous perimeter 122a. The sensor connection 130a is routed from the processing circuit 202, through passthrough 30b at the boundary of the second continuous perimeter 122b, into the first protected volume 124a, and to the first continuous perimeter 122a. A sensor connection 130b couples the processing circuit 202 to the second continuous perimeter 122b for monitoring the sensor structures of the second continuous perimeter 122b. The sensor connection 130b is routed within the second protected volume 124b. This nested arrangement provides defense in depth, requiring an attacker to defeat two independent tamper-detection perimeters to access the processing circuit 202 and the cryptographic keys stored therein.

FIG. 19 is a cross-section view of a tamper-responsive passthrough module 10 according to an illustrative embodiment, showing spatially distributed sensor coupling elements. The sensor structure 12, shown in cross-hatching, comprises a first sensor element portion forming an outer boundary and a second sensor element portion forming an inner boundary, spatially separated from each other. The passthrough is bounded by the first sensor element portion on a first side and by the second sensor element portion on a second side. Openings 16a are formed through the sensor structure 12, connected by a non-linear path 18 shown as a dashed line. A plurality of sensor coupling elements 22a, 22b, 22c, 22d, 22e, and 22f are distributed at multiple positions between the first and second sensor element portions, connecting them and constraining relative movement between them. The sensor coupling elements are positioned on the inside of the module such that accessing any coupling element from outside the module requires traversing the sensor structure 12. A functional element 128 is routed through the passthrough along the non-linear path 18 between the first and second sensor element portions. The spatial distribution of the sensor coupling elements ensures that tilting, bending, or displacement of one sensor element portion relative to the other causes a detectable change in at least one measurable property.

Those having ordinary skill in the art and access to the present teachings will recognize additional modifications, applications, and embodiments within the scope thereof.

It is, therefore, intended by the appended claims to cover any and all such applications, modifications and embodiments within the scope of the present invention.

1. A tamper-responsive passthrough module comprising:
(a) at least one sensor structure comprising at least one sensor element;
(b) at least one passthrough defined through the sensor structure, the passthrough comprising a plurality of openings connected by a non-linear path;
(c) wherein physical stimulus upon the sensor structure causes a detectable change in at least one property of the sensor structure; and
(d) wherein the non-linear path is bounded by the sensor structure such that any straight-line path through the passthrough intersects the sensor structure.

2. The tamper-responsive passthrough module of claim 1, further comprising a terminal interface operationally coupled to the sensor element and configured to couple to at least one of another tamper-responsive module or an external processing circuit.

3. The tamper-responsive passthrough module of claim 1, wherein:
(a) the at least one sensor structure comprises a first sensor element portion and a second sensor element portion spatially separated from each other;
(b) the passthrough is bounded by the first sensor element portion on a first side and by the second sensor element portion on a second side; and
(c) an object traversing the passthrough must follow the non-linear path between the first and second sensor element portions.

4. The tamper-responsive passthrough module of claim 3, further comprising a sensor coupling element establishing at least one measurable property between the first sensor element portion and the second sensor element portion, wherein the sensor coupling element is positioned on an inside of the module such that accessing the coupling element from outside the module requires traversing the sensor structure, and wherein separation or displacement of the first and second sensor element portions causes a detectable change in the at least one measurable property.

5. The tamper-responsive passthrough module of claim 4, wherein the sensor coupling element comprises a plurality of spatially distributed coupling connections between the first and second sensor element portions, the spatial distribution constraining relative movement between the sensor element portions such that tilting or bending of one sensor element portion relative to the other causes a detectable change.

6. The tamper-responsive passthrough module of claim 5, wherein the sensor structure has sufficient rigidity such that deformation of the sensor structure that does not trigger the detectable change does not create an opening between the first and second sensor element portions large enough to permit bypassing the sensor structure.

7. The tamper-responsive passthrough module of claim 1, wherein the at least one sensor element is covered by at least one shielding layer.

8. The tamper-responsive passthrough module of claim 1, wherein the at least one sensor structure comprises a plurality of stacked layers, and wherein the passthrough traverses the plurality of stacked layers via the non-linear path.

9. The tamper-responsive passthrough module of claim 8, wherein the non-linear path comprises:
(a) a first passage through a first layer;
(b) a lateral displacement region; and
(c) a second passage through a second layer.

10. The tamper-responsive passthrough module of claim 1, wherein the non-linear path comprises at least one lateral displacement having a length that is at least two times a perpendicular distance between portions of the sensor structure bounding the lateral displacement.

11. The tamper-responsive passthrough module of claim 1, wherein the sensor element comprises at least one conductive trace configured to exhibit a change in at least one electrical property upon physical stimulus.

12. The tamper-responsive passthrough module of claim 1, wherein the sensor element comprises at least one of: an optical fiber or a planar optical waveguide, disposed on or within the sensor structure, configured to exhibit a change in at least one optical property upon physical stimulus.

13. The tamper-responsive passthrough module of claim 1, wherein the at least one sensor structure comprises a plurality of sensor layers alternating with layers of thermally conductive material, the layers of thermally conductive material being continuous across the sensor structure, such that a straight cut through the sensor structure necessarily intersects at least one sensor layer.

14. A tamper-detection system comprising:
(a) at least one tamper-responsive module, each comprising at least one sensor structure comprising at least one sensor element;
(b) at least one passthrough defined through the sensor structure of at least one tamper-responsive module, the passthrough comprising a plurality of openings connected by a non-linear path;
(c) a processing circuit operationally coupled to the sensor structure;
(d) wherein physical stimulus upon the sensor structure causes a detectable change in at least one property of the sensor structure;
(e) wherein the non-linear path is bounded by the sensor structure such that any straight-line path through the passthrough intersects the sensor structure; and
(f) wherein the processing circuit is configured to detect tampering based on changes in at least one measurable property of the sensor structure.

15. The tamper-detection system of claim 14, wherein the at least one module is arranged to form a continuous perimeter enclosing a protected volume.

16. The tamper-detection system of claim 15, comprising a plurality of tamper-responsive modules coupled to form the continuous perimeter.

17. The tamper-detection system of claim 16, wherein the plurality of coupled modules establish at least one measurable property between adjacent modules, and wherein decoupling or displacement of adjacent modules causes a detectable change in the at least one measurable property.

18. The tamper-detection system of claim 16, wherein a coupling between adjacent tamper-responsive modules is disposed on an interior side of the continuous perimeter facing the protected volume, such that accessing the coupling from outside the protected volume requires traversing the sensor structure of at least one tamper-responsive module.

19. The tamper-detection system of claim 16, wherein the processing circuit is configured to periodically verify integrity of the coupling between adjacent tamper-responsive modules by measuring at least one property of a sensor path through the plurality of coupled modules, and wherein removal or displacement of any tamper-responsive module from the continuous perimeter causes a detectable change in the measured property.

20. The tamper-detection system of claim 16, wherein adjacent tamper-responsive modules are arranged such that the sensor structure of one module overlaps with the sensor structure of an adjacent module at their shared boundary, such that any intrusion attempt at the joint between adjacent modules must traverse at least one sensor structure.

21. The tamper-detection system of claim 15, wherein a sensor connection between the sensor structure and the processing circuit is routed within the protected volume such that the sensor connection is inaccessible from outside the continuous perimeter without traversing at least one sensor structure.

22. The tamper-detection system of claim 15, further comprising a second continuous perimeter enclosing a second protected volume nested within the protected volume, the second continuous perimeter comprising at least one tamper-responsive module with at least one sensor structure, wherein the processing circuit is configured to monitor the sensor structures of both the continuous perimeter and the second continuous perimeter.

23. The tamper-detection system of claim 14, wherein at least one functional element is routed through the passthrough, selected from:
(a) electrical power conductors;
(b) electrical signal conductors;
(c) optical signal conductors;
(d) cooling fluid;
(e) cooling gas;
(f) thermally conductive material; or
(g) mechanical fastening elements.

24. The tamper-detection system of claim 14, wherein the processing circuit is configured to measure at least one of: resistance, capacitance, impedance, signal propagation time, signal reflection characteristics, optical attenuation, or optical signal propagation time.

25. The tamper-detection system of claim 14, wherein the processing circuit is configured to:
(a) monitor a rate of change of at least one measurable property between successive measurements; and
(b) trigger a tamper event when the rate of change exceeds a configurable rate threshold.

26. The tamper-detection system of claim 14, wherein the processing circuit is configured to trigger at least one response upon detecting tampering, selected from:
(a) deletion of cryptographic keys;
(b) erasure of sensitive data;
(c) destruction of sensitive hardware components; or
(d) generation of a tamper alert notification.

27. The tamper-detection system of claim 15, further comprising:
(a) a power management unit operationally coupled to the processing circuit;
(b) an internal battery disposed within the protected volume, the internal battery providing sufficient energy to complete zeroization of cryptographic keys and sensitive data; and
(c) at least one external battery disposed outside the protected volume.

28. The tamper-detection system of claim 27, comprising at least two external batteries connected in parallel via the power management unit, wherein any single external battery is removable and replaceable without interrupting power to the processing circuit.

29. A method of providing tamper-detected access through a tamper-detection module, comprising:
(a) providing a sensor structure having at least one measurable property;
(b) defining a passthrough through the sensor structure, wherein the passthrough follows a non-linear path bounded by the sensor structure;
(c) routing at least one functional element through the passthrough along the non-linear path; and
(d) monitoring the measurable property to detect physical manipulation of the sensor structure.

30. The method of claim 29, further comprising triggering a tamper event when at least one of:
(a) a deviation between a current value and a reference value exceeds a configurable tolerance; or
(b) a rate of change of the measurable property between successive measurements exceeds a configurable rate threshold.
